(19) United States
(12) Patent Application Publication
(10) Pub. No.: US 2004/0083097 A1
(43) Pub. Date: Apr. 29, 2004

(54) Optimized windows and interpolation factors, and methods for optimizing windows, interpolation factors and linear prediction analysis in the ITU-T G.729 speech coding standard

(76) Inventors: Wai Chung Chu, San Jose, CA (US); Toshio Miki, Cupertino, CA (US)

Correspondence Address: INDIANAPOLIS OFFICE 27879, BRINKS HOFER GILSON & LIONE, ONE INDIANA SQUARE, SUITE 1600, INDIANAPOLIS, IN, 46204-2033, US

(21) Appl. No.: 10/366,821

(22) Filed: Feb. 14, 2003

Related U.S. Application Data
(63) Continuation-in-part of application No. 10/282,966, filed on Oct. 29, 2002.

(51) Int. Cl. G10L 19/10; G10L 19/08

(52) U.S. Cl. 704/219

(57) ABSTRACT

Alternate window optimization procedures and/or LSP interpolation factor optimization procedures are used to improve the ITU-T G.729 speech coding standard (the “Standard”) by replacing the window used by the Standard with an optimized window and/or replacing the LSP interpolation factor used by the standard with an optimized LSP interpolation factor. Optimized windows created using the alternate window optimization procedure and/or optimized LSP interpolation factors created using the LSP interpolation factor optimization procedure yield improvements in the objective quality of synthesized speech produced by the Standard. In many cases, improvements are obtained using shorter windows, which results in reduced computational cost and/or smaller future buffering requirements, which results in lowered coding delay. The improved Standard, procedures, and optimized windows and LSP interpolation factors can all be implemented as computer readable software code and in optimization devices.

### RELATED APPLICATIONS

The application is a continuation-in-part of the US patent application entitled “Method and Apparatus for Gradient-Descent Based Window Optimization for Linear Prediction Analysis,” application serial number not yet assigned, Attorney Docket Number 10745-162, filed Nov. 2, 2002, which is incorporated herein by reference; and the US patent application entitled “Optimized Window and Methods Therefore for Gradient-Descent Based Window Optimization for Linear Prediction Analysis in the ITU-T G.723.1 Speech Coding Standard,” application serial number not yet assigned, Attorney Docket Number 10745-163, filed Dec. 17, 2002, which is incorporated herein by reference.

### BACKGROUND

Speech analysis involves obtaining characteristics of a speech signal for use in speech-enabled and/or related applications, such as speech synthesis, speech recognition, speaker verification and identification, and enhancement of speech signal quality. Speech analysis is particularly important to speech coding systems.

Speech coding refers to the techniques and methodologies for efficient digital representation of speech and is generally divided into two types, waveform coding systems and model-based coding systems. Waveform coding systems are concerned with preserving the waveform of the original speech signal. One example of a waveform coding system is the direct sampling system which directly samples a sound at high bit rates (“direct sampling systems”). Direct sampling systems are typically preferred when quality reproduction is especially important. However, direct sampling systems require a large bandwidth and memory capacity. A more efficient example of waveform coding is pulse code modulation.

In contrast, model-based speech coding systems are concerned with analyzing and representing the speech signal as the output of a model for speech production. This model is generally parametric and includes parameters that preserve the perceptual qualities and not necessarily the waveform of the speech signal. Known model-based speech coding systems use a mathematical model of the human speech production mechanism referred to as the source-filter model.

The source-filter model models a speech signal as the air flow generated from the lungs (an “excitation signal”), filtered with the resonances in the cavities of the vocal tract, such as the glottis, mouth, tongue, nasal cavities and lips (a “synthesis filter”). The excitation signal acts as an input signal to the filter similarly to the way the lungs produce air flow to the vocal tract. Model-based speech coding systems using the source-filter model generally determine and code the parameters of the source-filter model. These model parameters generally include the parameters of the filter. The model parameters are determined for successive short time intervals or frames (e.g., 10 to 30 ms analysis frames), during which the model parameters are assumed to remain fixed or unchanged. However, it is also assumed that the parameters will change with each successive time interval to produce varying sounds.

The parameters of the model are generally determined through analysis of the original speech signal. Because the synthesis filter generally includes a polynomial equation including several coefficients to represent the various shapes of the vocal tract, determining the parameters of the filter generally includes determining the coefficients of the polynomial equation (the “filter coefficients”). Once the synthesis filter coefficients have been obtained, the excitation signal can be determined by filtering the original speech signal with a second filter that is the inverse of the synthesis filter (an “analysis filter”).

One method for determining the coefficients of the synthesis filter is through the use of linear predictive analysis (“LPA”) techniques or processes. LPA is a time-domain technique based on the concept that during a successive short time interval or frame “N,” each sample of a speech signal (“speech signal sample” or “s[n]”) is predictable through a linear combination of samples from the past s[n−k] together with the excitation signal u[n]. The speech signal sample s[n] can be expressed by the following equation:

$$s [ n ] = {\sum }_{k = 1}^{M} {a}_{k} s [ n - k ] + Gu [ n ] \qquad ( 1 )$$

where G is a gain term representing the loudness over a frame with a duration of about 10 ms, M is the order of the polynomial (the “prediction order”), and aₖ are the filter coefficients which are also referred to as the “LP coefficients.” The filter is therefore a function of the past speech samples s[n] and is represented in the z-domain by the formula:

H[z]=G/A[z] (2)

A[z] is an M order polynomial given by:

$$A [ z ] = 1 + {\sum }_{k = 1}^{M} {a}_{k} {z}^{- k} \qquad ( 3 )$$

The order of the polynomial A[z] can vary depending on the particular application, but a 10th order polynomial is commonly used with an 8 kHz sampling rate.

The LP coefficients a₁ . . . a_{M} are computed by analyzing the actual speech signal s[n]. The LP coefficients are approximated as the coefficients of a filter used to reproduce s[n] (the “synthesis filter”). The synthesis filter uses the same LP coefficients as the analysis filter and produces a synthesized version of the speech signal. The synthesized version of the speech signal may be estimated by a predicted value of the speech signal \tilde{s}[n]. \tilde{s}[n] is defined according to the formula:

$$\tilde{s} [ n ] = - {\sum }_{k = 1}^{M} {a}_{k} s [ n - k ] \qquad ( 4 )$$

Because s[n] and \tilde{s}[n] are not exactly the same, there will be an error associated with the predicted speech signal \tilde{s}[n] for each sample n referred to as the prediction error eₚ[n], which is defined by the equation:

$${e}_{p} [ n ] = s [ n ] - \tilde{s} [ n ] = s [ n ] + {\sum }_{k = 1}^{M} {a}_{k} s [ n - k ] \qquad ( 5 )$$

Where the sum of all the prediction errors defines the total prediction error Eₚ:

$${E}_{p} = \sum {e}_{p}^{2} [ k ] \qquad ( 6 )$$

where the sum is taken over the entire speech signal. The LP coefficients a₁ . . . a_{M} are generally determined so that the total prediction error Eₚ is minimized (the “optimum LP coefficients”).

One common method for determining the optimum LP coefficients is the autocorrelation method. The basic procedure consists of signal windowing, autocorrelation calculation, and solving the normal equation leading to the optimum LP coefficients. Windowing consists of breaking down the speech signal into frames or intervals that are sufficiently small so that it is reasonable to assume that the optimum LP coefficients will remain constant throughout each frame. During analysis, the optimum LP coefficients are determined for each frame. These frames are known as the analysis intervals or analysis frames. The LP coefficients obtained through analysis are then used for synthesis or prediction inside frames known as synthesis intervals. However, in practice, the analysis and synthesis intervals might not be the same.

When windowing is used, assuming for simplicity a rectangular window of unity height including window samples w[n], the total prediction error Ep in a given frame or interval may be expressed as:

$${E}_{p} = {\sum }_{k = n1}^{n2} {e}_{p}^{2} [ k ] \qquad ( 7 )$$

where n1 and n2 are the indexes corresponding to the beginning and ending samples of the window and define the synthesis frame.

Once the speech signal samples s[n] are isolated into frames, the optimum LP coefficients can be found through autocorrelation calculation and solving the normal equation. To minimize the total prediction error, the values chosen for the LP coefficients must cause the derivative of the total prediction error with respect to each LP coefficients to equal or approach zero. Therefore, the partial derivative of the total prediction error is taken with respect to each of the LP coefficients, producing a set of M equations. Fortunately, these equations can be used to relate the minimum total prediction error to an autocorrelation function:

$${E}_{p} = {R}_{p} [ 0 ] - {\sum }_{i = 1}^{M} {a}_{i} {R}_{p} [ k ] \qquad ( 8 )$$

where M is the prediction order and Rₚ(k) is an autocorrelation function for a given time-lag/which is expressed by:

$$R [ l ] = {\sum }_{k = l}^{N - 1} w [ k ] s [ k ] w [ k - l ] s [ k - l ] \qquad ( 9 )$$

where s[k] are speech signal sample, w[k] are the window samples that together form a plurality of window each of length N (in number of samples) and s[k−l] and w[k−l] are the input signal samples and the window samples lagged by l. It is assumed that w[n] may be greater than zero only from k=0 to N−1. Because the minimum total prediction error can be expressed as an equation in the form Ra=b (assuming that Rₚ[0] is separately calculated), the Levinson-Durbin algorithm may be used to solve the normal equation in order to determine for the optimum LP coefficients.

Many factors affect the minimum total prediction error including the shape of the window in the time domain and the accuracy of the excitation signal. In many cases, an excitation signal is represented by one or more parameters (the “excitation parameters”). For example, in code-excited linear prediction type speech coding systems (“CELP-type speech coding systems” or “CELP-type speech coders”) the excitation signal is represented by an index that corresponds to an excitation signal in a codebook. The excitation signal for most CELP coders is actually the result of the addition of two components: an excitation codevector from the adaptive codebook which is scaled by the adaptive codebook gain, and an excitation codevector from the fixed codebook which is scaled by the fixed codebook gain. Generally, a close-loop analysis-by-synthesis procedure is applied to determine the optimal codevectors and gains.

In many coding standards, the excitation parameters are obtained using the LP coefficients. In these standards, some of the LP coefficients are determined using autocorrelation and the remaining LP coefficients are determined by interpolating the LP coefficients found autocorrelation. To perform this interpolation, the LP coefficients are transformed into the frequency domain where they are represented by line spectral pair (“LSP,” also known as “line spectral frequencies” or “LSF”) coefficients. The interpolation is generally defined as a function of an LSP interpolation factor a. Therefore, the accuracy with which the excitation parameters are obtained depends, in part, on the accuracy of the LSP interpolation factor a and the accuracy with which the excitation parameters are obtained can have an effect of the minimum total prediction error.

The shape of the window used to determine the synthesis filter can also affect the minimum total prediction error. In many coding standards, the window used to break the speech signal into frames often has a non-square shape to emphasize portions of the speech signal that are more significant to human perception of speech (“perceptual weighting”). Generally, these windows have a shape that includes tapered-ends so that the amplitudes are low at the beginning and end of the window with a peak amplitude located in-between. These windows are described by simple formulas and their selection inspired by the application in which they are used.

In general, known methods for choosing the shape of the window and the interpolation factor are heuristic. There is no deterministic method for determining the optimum window shape or the LSP interpolation factor. For example, the speech coding system defined by the ITU-T G.729 speech coding standard (the “G.729 standard”) uses a 240 sample window consisting of two parts. The first part is half a Hamming window and the second part is a quarter of a cosine function (together the “G.729 window”). The G.729 window is shown in FIG. 1 and defined according to the following equations:

$$w [ n ] = \{ \begin{matrix}0.54 - 0.46 cos ( \frac{2 π n}{399} ) ; & n = 0 , … , 199 \\ cos ( \frac{2 π ( n - 200 )}{159} ) ; & n = 200 , … , 239\end{matrix} \qquad ( 10 )$$

Unfortunately, the G.729 standard does not include a method for determining whether the G.729 window will yield the optimum LP coefficients.

The G.729 standard is designed for wireless and multimedia network applications. It is an analysis-by-synthesis conjugate structure algebraic CELP (“CS-ACELP”) speech coder designed for coding speech signals at 8 kbits/s. (See “Coding of Speech at 8 kbits/s Using Conjugate-Structure Algebraic-Code-Excited Linear-Prediction (CS-ACELP), ITU-T Recommendations G.729 1996,” which is incorporated herein by reference).

The particular LPA used by the G.729 standard (the “G.729 LPA procedure”) is shown in FIG. 2 and indicated by reference number 10. In general, the G.729 LPA procedure 10 creates and then operates on 10 ms frames of a speech signal, where each frame corresponds to 80 samples at a sampling rate of 8000 samples/second. For every frame created, the speech signal is analyzed to extract the LP coefficients, gains, and excitation parameters which are then encoded for transmission or storage. More specifically, the G.729 LPA procedure determines a set of LP coefficients for the entire frame using autocorrelation, where the LP coefficients are used to define the synthesis filter (the “unquantized LP coefficients”). However, for purposes of determining the excitation signal, the G.729 procedure divides each frame into two equal-length subframes and determines an additional set of LP coefficient for each subframe. The LP coefficients for the second subframe (the “quantized LP coefficients”) are determined by quantizing the unquantized. LP coefficients in the frequency domain. The LP coefficients for the first subframe are determined through interpolation in the frequency domain of the quantized LP coefficients for second frame.

The steps of the G.729 LPA procedure, as shown in FIG. 2, generally include: high pass filtering and scaling the speech signal 12 to define a preprocessed speech signal; windowing the preprocessed speech signal with a G.729 window 14 to define the current frame; determining the unquantized LP coefficients of the current frame through autocorrelation 16; transforming the unquantized LP coefficients of the current frame into LSP coefficients of the second subframe of the current frame 18; quantizing the LSP coefficients of the second subframe of the current frame 20; interpolating the quantized LSP coefficients of the second subframe to create the quantized LSP coefficients of the first subframe of the current frame 22; and transforming the quantized LSP coefficients of the first and second subframes into the quantized LP coefficients of the first and second subframes, respectively 22.

High pass filtering and scaling the speech signal 12 to create a preprocessed speech signal basically includes filtering out the undesired low frequency components of the speech signal and scaling the speech signal by a factor of two to reduce the possibility of overflows in the fixed-point implementation, respectively. Windowing the preprocessed speech signal 14 basically includes windowing the filtered speech signal to create a frame of the preprocessed speech signal. The preprocessed speech signal is windowed with a G.729 window which is centered so as to include 120 samples from past frames, 80 samples from the current frame and 40 samples from the future frame. For example, if the current frame is located at n∈[0, 79], the corresponding interval for the 729 window is [−120, 119]. This means that the G.729 LPA procedure must look ahead 5 ms from the current frame which requires that 40 samples from the future frame be placed in a buffer before LPA of the current frame can begin. Determining the unquantized LP coefficients through autocorrelation includes performing the autocorrelation calculation and solving the normal equation using the Levinson-Durbin algorithm as described previously herein. The unquantized LP coefficients determined in steps 12, 14 and 16 are then used to define the synthesis filter.

The unquantized LP coefficients are also used to determine the quantized LP coefficients for the first and second subframes of each frame, which, in turn, are used to determine the excitation parameters. Transforming the unquantized LP coefficients of the current frame into the LSP coefficients of the second subframe of the current frame 18 can be accomplished using known transformation techniques. Quantizing the LSP coefficients of the second subframe of the current frame 20 includes using predictive two-stage vector quantization with 18 bits. Interpolating the quantized LSP coefficients of the second subframe to create the quantized LSP coefficients of the first subframe of the current frame 22 includes interpolating the quantized LSP coefficients of the second subframe of the current frame with the quantized LSP coefficient of the second subframe of the prior frame to create the quantized LSP coefficients of the first subframe of the current frame. The interpolation is performed according to the following equation:

u₀=(1−α)uₚₐₛₜ+αu₁ (11)

where u₀ is the LSP coefficients of the first subframe of the current frame, u₁ is the LSP coefficients of the second subframe of the current frame, uₚₐₛₜ is the LSP coefficients of the second subframe of the prior frame and a is the LSP interpolation factor which, in the G.729 standard, is equal to 0.5. Transforming the quantized LSP coefficients of the first and second subframes into the quantized LP coefficients of the first and second subframes, respectively 24 may be accomplished using known techniques. The quantized LP coefficients of the first and second subframes may then be used to determine the excitation parameters. The entire procedure is repeated for each frame of the preprocessed speech signal. Alternatively, each step, after the step of high pass filtering and scaling the speech signal 12, may be performed for every frame of speech before performing the next step.

### BRIEF SUMMARY

An improved G.729 standard has been created primarily by replacing the G.729 LPA procedure with an optimized LPA procedure. Embodiments of the optimized LPA procedure are generally created by replacing the G.729 window used in the G.729 LPA procedure with an optimized G.729 window, replacing the G.729 LSP interpolation factor with an optimized G.729 interpolation factor, or making both replacements. The improved G.729 can be implemented with a smaller window size and lower future buffering requirement as compared with the G.729 without any significant loss in subjective quality.

The G.729 window is generally optimized by an alternate window optimization procedure. This alternate window optimization procedure relies on the principle of gradient-descent to find a window sequence that will either minimize the prediction error energy or maximize the segmental prediction gain. Furthermore, the alternate window optimization procedure uses an estimate based on the basic definition of a partial derivative.

The G.729 LSP interpolation factor is generally optimized by an LSP interpolation factor optimization procedure. This procedure uses an iterative approach based on a fixed step size search approach wherein the G.729 LSP interpolation factor is altered by a step of fixed size in a direction that increases the segmental prediction gain (“SPG”) of the synthesized speech produced by the improved G.729 speech coding system.

Furthermore, both the G.729 window and the G.729 LSP interpolation factors can be jointly optimized using a joint window and LSP interpolation factor optimization procedure. The joint window and LSP interpolation factor optimization procedure basically combines the procedures of the alternate window optimization procedure and the LSP interpolation factor optimization procedure into an iterative process, where the LSP interpolation factor is adjusted each time the window has been optimized until some stop criterion has been reached.

Also presented herein are windows optimized using the alternate window optimization procedures and windows and LSP interpolation factors optimized using the joint window and LSP interpolation factor optimization procedure. The efficacy of these optimized windows and optimized LSP interpolation factors for use in the G.729 standard is demonstrated through test data showing improvements in objective speech quality. Additionally shown is that the optimized windows and/or the optimized LSP interpolation factors can be implemented with a lower future buffering requirement and using windows with fewer samples while the subjective quality is essentially maintained.

These optimization procedures, the optimized windows and LSP interpolation factors and the methods for optimizing the G.729 standard can be implemented as computer readable software code which may be stored on a processor, a memory device or on any other computer readable storage medium. Alternatively, the software code may be encoded in a computer readable electronic or optical signal. Additionally, the optimization procedures, the optimized windows and LSP interpolation factors and the methods for optimizing the G.729 standard may be implemented in an optimization device which generally includes an optimization unit and may also include an interface unit. The optimization unit includes a processor coupled to a memory device. The processor performs the optimization procedures and obtains the relevant information stored on the memory device. The interface unit generally includes an input device and an output device, which both serve to provide communication between the window optimization unit and other devices or people.

### BRIEF DESCRIPTION OF THE DRAWINGS

This disclosure may be better understood with reference to the following figures and detailed description. The components in the figures are not necessarily to scale, emphasis being placed upon illustrating the relevant principles. Moreover, like reference numerals in the figures designate corresponding parts throughout the different views.

FIG. 1 is a graph of the G.729 window according to the prior art;

FIG. 2 is a flow chart of the linear predictive analysis used by the G.729 speech coding standard according to the prior art;

FIG. 3 is a flow chart of one embodiment of an alternate window optimization procedure;

FIG. 4 is a flow chart of one embodiment of an LSP interpolation factor optimization procedure;

FIG. 5 is a flow chart of one embodiment of a joint window and LSP interpolation factor optimization procedure;

FIG. 6 is a flow chart of one embodiment of an LSP interpolation factor adjustment procedure;

FIG. 7 is a table summarizing the characteristics of the G.729 window and the optimized G.729 windows;

FIG. 8 is a graph of SPG as a function of training epoch;

FIG. 9 is a graph of the LSP interpolation factor as a function of training epoch;

FIG. 10A is a graph of the G.729 window and an embodiment of an optimized G.729 window obtained through experimentation, where the embodiment of the optimized window is 240 samples in length and requires 40 samples of future buffering;

FIG. 10B is a graph of the G.729 window and an additional embodiment of an optimized G.729 window obtained through experimentation, where the additional embodiment of an optimized G.729 window has a window length of 160 samples and a future buffering requirement of 40 samples;

FIG. 10C is a graph of the G.729 window and an additional embodiment of an optimized G.729 window obtained through experimentation, where the additional embodiment of an optimized G.729 window has a window length of 80 samples and a future buffering requirement of 20 samples;

FIG. 10D is a graph of the G.729 window and an additional embodiment of an optimized G.729 window obtained through experimentation, where the additional embodiment of an optimized G.729 window has a window length of 120 samples and no future buffering requirement;

FIG. 10E is a graph of the G.729 window and an additional embodiment of an optimized G.729 window obtained through experimentation, where the additional embodiment of an optimized G.729 window has a window length of 120 samples and a future buffering requirement of 20 samples;

FIG. 10F is a graph of the G.729 window and an additional embodiment of an optimized G.729 window obtained through experimentation, where the additional embodiment of an optimized G.729 window has a window length of 120 samples and a future buffering requirement of 20 samples;

FIG. 10G is a graph of the G.729 window and an additional embodiment of an optimized G.729 window obtained through experimentation, where the additional embodiment of an optimized G.729 window has a window length of 120 samples and a future buffering requirement of 10 samples;

FIG. 10H is a graph of the G.729 window and an additional embodiment of an optimized G.729 window obtained through experimentation, where the additional embodiment of an optimized G.729 window has a window length of 120 samples and no future buffering requirement;

FIG. 11 is a flow chart of one embodiment of an improved linear predictive analysis process for use in the G.729 speech coding standard;

FIG. 12 is a table of the experimentally obtained segmental prediction gain and the prediction error power resulting from an ITU-T G.729 speech coding standard using the G.729 window and the optimized G.729 windows; and

FIG. 13 is a block diagram of one embodiment of a window optimization device.

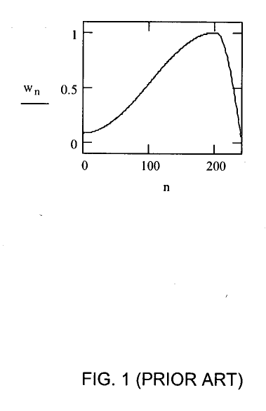

### DETAILED DESCRIPTION

Optimization procedures have been developed which decrease the computational load and/or buffer requirements for, and in some cases, improve the quality of speech signals reproduced by the G.729 standard. These optimization procedures include procedures for optimizing the shape of the window used during LPA (“window optimization procedures”) and optimizing the LSP interpolation factors (“LSP interpolation factor optimization procedures”). Additionally, optimized windows and optimized LSP interpolation factors are obtained through the aforementioned methods, respectively. These optimized windows and LSP interpolation factors are used either alone or in combination to create optimized LPA procedures which are then made part of a speech coding standard, such as the G.729 standard, to create an improved standard.

The window optimization procedures are generally based on gradient-descent based methods, through the use of which window optimization may be achieved fairly precisely with a primary window optimization procedure or less precisely with an alternate window optimization procedure. The primary window optimization and the alternate window optimization procedures both include finding a window that will either minimize the prediction error energy (“PEEN”) or maximize the prediction gain (“PG”). Additionally, although the primary window optimization procedures and the alternate window optimization procedures involve determining a gradient, the primary window optimization procedure uses a Levinson-Durbin based algorithm to determine the gradient while the alternate window optimization procedure uses the basic definition of a partial derivative to estimate the gradient.

The LSP interpolation factor optimization procedures are based on a fixed step size search algorithm through which LSP interpolation factor optimization may be achieved. The LSP interpolation factor optimization procedures include adjusting the LSP interpolation factor by fixed increments or step sizes in a direction which results in an increase in SPG. When used together with a window optimization procedure (a “joint window and interpolation factor optimization procedure”), the LSP interpolation factor optimization procedure increments the LSP interpolation factor by a fixed step size or increment in an incrementatation direction, if such an increment yields a new LSP interpolation factor that results in an increase in or similar value for SPG for the speech coding system. Therefore, in subsequent iterations of the joint window and interpolation factor optimization procedure, after the window has optimized, the new LSP interpolation factor is again incremented by the same fixed step size in the same incrementation direction. If the increment does not result in an increase in or similar value for SPG, the LSP interpolation factor is not incremented, however, the incrementation direction is reversed. Therefore, in subsequent iterations of the joint window and interpolation factor optimization procedure, after the window has optimized, the LSP interpolation factor is incremented by the same fixed step size but in the opposite direction.

Improvements in LPA procedures may be obtained by using optimized windows and/or optimized LSP interpolation factors. These improved LPA procedures are referred to as “optimized LPA procedures.” Improvements are demonstrated by experimental data that compares the time-averaged PEEN (the “prediction-error power” or “PEP”) and the time-averaged PG (the “segmental prediction gain” or “SPG”) of a speech coding standard using an LPA procedure and the same speech coding standard using the various embodiments of the optimized LPA procedures.

The window optimization procedures optimize the shape of the window and the LSP interpolation factor by minimizing the PEEN or maximizing PG. The PG at the synthesis interval n∈[n₁, n₂] is defined by the following equation:

$$PG = 10 {log}_{10} ( {\sum }_{n = {n}_{1}}^{{n}_{2}} {( s [ n ] )}^{2} / {\sum }_{n = {n}_{1}}^{{n}_{2}} {( e [ n ] )}^{2} ) , \qquad ( 12 )$$

wherein PG is the ratio in decibels (“dB”) between the speech signal energy and prediction error energy. For the same synthesis interval n∈[n₁, n₂], the PEEN is defined by the following equation:

$$J = {\sum }_{n = {n}_{1}}^{{n}_{2}} {( ⅇ [ n ] )}^{2} = {\sum }_{n = {n}_{1}}^{{n}_{2}} {( s [ n ] - \hat{s} [ n ] )}^{2} = {\sum }_{n = {n}_{1}}^{{n}_{2}} {( s [ n ] + {\sum }_{i = 1}^{M} {a}_{i} s [ n - i ] )}^{2} \qquad ( 13 )$$

wherein e[n] denotes the prediction error; s[n] and ŝ[n] denote the speech signal and the predicted speech signal, respectively; the coefficients aᵢ, for i=1 to M are the LP coefficients, with M being the prediction order. The minimum value of the PEEN, s denoted by J, occurs when the derivatives of J with respect to the LP coefficients equal zero.

Because the PEEN can be considered a function of the N samples of the window, the gradient of J with respect to the window can be determined from the partial derivatives of J with respect to each window sample:

$$∇ J = {[ \frac{\partial J}{\partial w [ 0 ]} \frac{\partial J}{\partial w [ 1 ]} ⋯ \frac{\partial J}{\partial w [ N - 1 ]} ]}^{T} , \qquad ( 14 )$$

where T is the transpose operator. By finding the gradient of J, it is possible to adjust the window in the direction negative to the gradient so as to reduce the PEEN. This is the principle of gradient-descent. The window can then be adjusted and the PEEN recalculated until a minimum or otherwise acceptable value of the PEEN is obtained.

The window optimization procedures obtain the optimum window by using LPA to analyze a set of speech signals and using the principle of gradient-descent. The set of speech signals {sₖ[n], k=0, 1, . . . , Nₜ₋₁} used is known as the training data set which has size Nₜ, and where each sₖ[n] is a speech signal which is represented as an array containing speech samples. Generally, the primary and alternate window optimization procedures include an initialization procedure, a gradient-descent procedure and a stop procedure. Because the gradient-descent procedure is iterative, an iteration index m is used to denote the current iteration. During the initialization procedure, the iteration index m is generally set equal to zero and an s initial window wₘ (m=0) is chosen and the PEP of the whole training set is computed, the results of which are denoted as PEP₀. PEP₀ is computed using the initialization routine of a Levinson-Durbin algorithm. The initial window wₘ (m=0) includes a number of window samples, each denoted by wₘ[n] (m=0) and can be chosen arbitrarily.

During the gradient-descent procedure, the gradient of the PEEN is determined and the window is updated in a direction negative to the gradient of the PEEN. The gradient of the PEEN is determined with respect to the window wₘ, using the recursion routine of the Levinson-Durbin algorithm, and the speech signal sₖ for all speech signals (k←0 to Nₜ−1). The window wₘ is updated as a function of itself and a window update increment (the “step size parameter”). The window update increment, or step size parameter, is generally defined prior to executing the optimization procedure.

The stop procedure includes determining if the threshold has been met. The threshold is also generally defined prior to using the optimization procedure and represents an amount of acceptable error. The value chosen to define the threshold is based on the desired accuracy. The threshold is met when the PEP for the whole training set PEPₘ, determined using window wₘ for the whole training set, has not decreased substantially with respect to the prior PEP, denoted as PEPₘ₋₁ (if m=0, then PEPₘ₋₁=0). Whether PEPₘ has decreased substantially with respect to the PEP of the prior iteration (“PEPₘ₋₁”) is determined by subtracting PEPₘ from PEPₘ₋₁ and comparing the resulting difference to the threshold. If the resulting difference is greater than the threshold, the gradient-descent procedure (including updating the iteration index so that m←m+1 ) and the stop procedure are repeated until the difference is equal to or less than the threshold. The performance of the window optimization procedure for each window, up to and including reaching the threshold, is know as one epoch. In the following description, the iteration index m, denoting the iteration to which each equation relates, is omitted in places where the omission improves clarity.

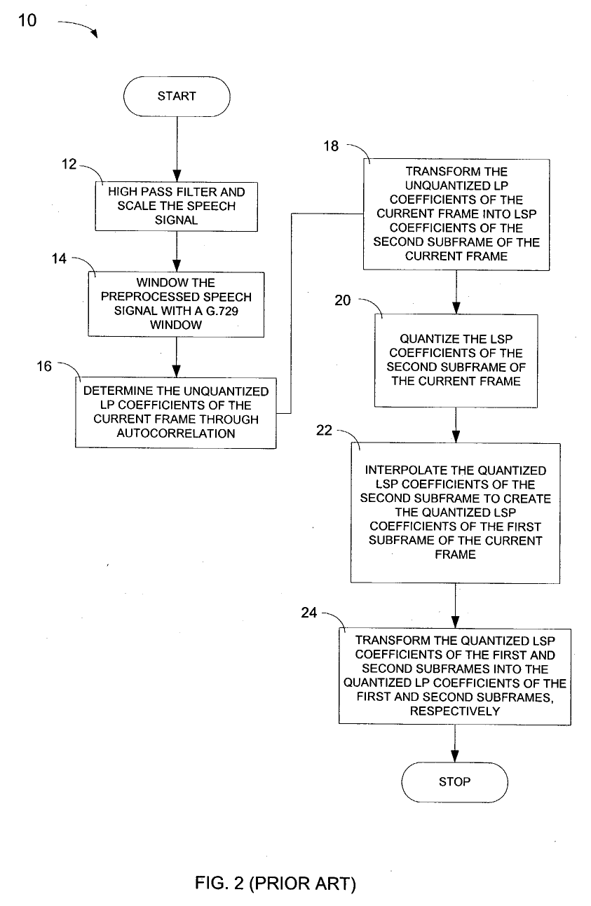

As applied to speech coding, linear prediction has evolved into a rather complex scheme where multiple transformation steps among the LP coefficients are common; some of these steps include bandwidth expansion, white noise correction, spectral smoothing, conversion to line spectral frequency, and interpolation. For example, as shown in FIG. 2, the G.729 standard includes conversions to and from line spectral pairs in steps 18 and 24, respectively, and interpolation in step 22. Under these circumstances, it is not feasible to find the gradient using the primary optimization procedure. Therefore, numerical method such as the alternate window optimization procedure can be used.

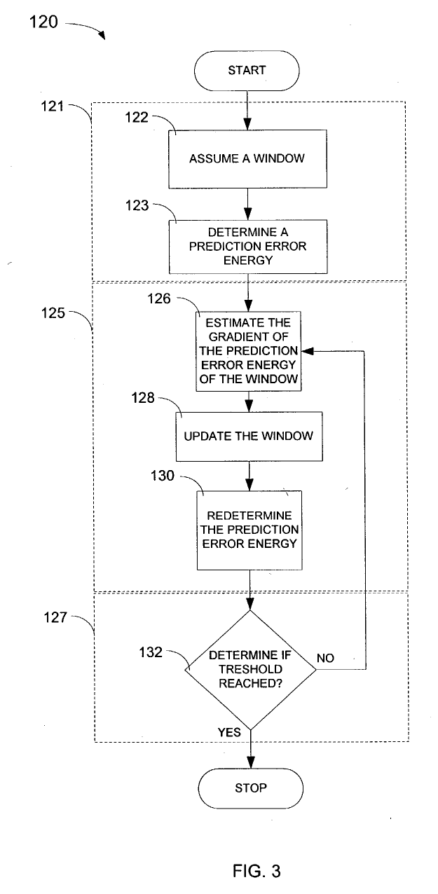

An embodiment of an alternate window optimization procedure 120 is shown in FIG. 3. Generally, the alternate window optimization procedure 120 includes an initialization procedure 121, a gradient-descent procedure 125 and a stop procedure 127. After a widow is assumed and the PEEN is determined with respect to that window (the “window PEEN”) in the initialization procedure 121, the window and the window PEEN are used as inputs to the gradient-descent procedure 125. The gradient-descent procedure 125 estimates the gradient of the window PEEN, in part, by creating an intermediate window from the window by slightly perturbing the window. After estimating the gradient of the window PEEN, the window is updated by adjusting the samples of the window in the direction negative to the gradient of the window PEEN. After the window is updated, the PEEN is redetermined in terms of the window as updated 130. Then the stop procedure 127 determines whether the redetermined PEEN is sufficiently low or if the gradient-descent procedure 125 needs to be repeated. If it is determined in step 127 that the PEEN is not sufficiently low, the gradient descent procedure 125 is repeated with the window as updated and the redetermined PEEN as the input for the next iteration of the gradient descent procedure 126.

The initialization procedure 121 includes assuming a window 122, and determining a prediction error energy 123. Assuming a window 122 generally includes establishing the shape of the window such as a rectangular window, a 729 window or any other window shape. Determining a prediction error energy 123 includes determining the prediction error energy as a function of the speech signal with respect to the window assumed (the window PEEN) using know autocorrelation-based LPA methods.

The gradient-descent procedure 125 includes estimating a gradient of the PEEN 126, updating the window 128, and redetermining the PEEN 130. Estimating a gradient of the PEEN 126 includes estimating the gradient of the window PEEN by creating an intermediate window wₘ′ that includes intermediate window samples w′[nₒ] where nₒ=0, . . . N−1, determining the PEEN with respect to each intermediate window sample (the “intermediate PEEN” or “J′[nₒ]”), and estimating the partial derivative of the window PEEN ∂J|∂w[nₒ].

Creating the intermediate window w′ includes defining the window samples of the intermediate window w′[n] according to the following equations:

w′[n]=w[n], n≠nₒ; w′[nₒ]=w[nₒ]+Δw, n=nₒ (15)

wherein the index nₒ=0 to N−1, and Δw is known as the window perturbation constant; for which a value is generally assigned prior to implementing the alternate window optimization procedure. The intermediate PEEN J′[nₒ] is determined by LP analysis of the input signal s[n], where the input signal is windowed by the intermediate window w′.

The gradient of the window PEEN is determined according to equation (14) which means that it is defined by the partial derivative of the window PEEN with respect to each sample of the window ∂J|∂w[nₒ]. These partial derivatives can be estimated according to the basic definition of a partial derivative, given in the following equation:

$$\frac{\partial f ( x )}{\partial x} = {l im}_{Δ x -> 0} \frac{f ( Δ x + x ) - f ( x )}{Δ x} , \qquad ( 16 )$$

wherein Δx represents a small perturbation of x, so that as Δx approaches zero, equation (16) estimates the derivative of the function f(x) more and more closely. According to this definition, the partial derivate of the window PEEN ∂J|∂w[nₒ] can be estimated as the difference between the intermediate PEEN J′[nₒ] and the window PEEN J, divided by the window perturbation constant Δw as expressed in the following equation:

$$\frac{\partial J}{\partial w [ {n}_{o} ]} \approx \frac{{J}^{′} [ {n}_{o} ] - J}{Δ w} \qquad ( 17 )$$

If the value of Δw is low enough, the estimate given in equation (17) will be close to the true value for the partial derivative of the window PEEN with respect to each sample of the window. Although the value of Δw should approach zero, that is, be as low as possible, in practice the value for Δw is selected in such a way that reasonable results can be obtained. For example, the value selected for the window perturbation constant Δw depends, in part, on the degree of numerical accuracy that the underlying system, such as a window optimization device, can handle. As determined through experimentation, a value for Δw of between approximately 10⁻⁷ and approximately 10⁻⁴ provides satisfactory results. However, the exact value selected for Δw will depend on the intended application.

After the gradient of the window PEEN is estimated, the window is updated. Updating the window 128 includes altering the window wₘ[n] in the direction negative to the gradient as estimated in step 126 to create an updated window wₘ[n]_{updated}; and defining the window wₘ[n] by the updated window wₘ[n]updated. The s updated window wₘ[n]_{updated} is defined by the equation:

$${{w}_{m} [ n ]}_{updated} = {w}_{m} [ n ] - μ \cdot \frac{\partial J}{\partial {w}_{m} [ n ]} ; n = 0 , ⋯ , N - 1 \qquad ( 18 a )$$

wherein as previously discussed, m is the iteration index indicating the current iteration of the gradient descent procedure;

$$\frac{\partial J}{\partial {w}_{m} [ n ]}$$

is the gradient of the PEEN with respect to each sample of the window for the current iteration m; and μ is a step size parameter. The step size parameter μ is a constant that determines the adaptation speed and is generally chosen experimentally for an intended application prior to performing the gradient descent procedure 125. In the context of the G.729 standard, acceptable results have been obtained for a step size parameter μ equal to approximately 10⁻⁹. Once the updated window is determined, the window is defined by the updated window according to the equation:

wₘ[n]←wₘ[n]_{updated} (18b)

After the window wₘ[n] is redefined as the updated window wₘ[n], a new prediction error energy is determined. Determining a new prediction error energy 130 includes determining the prediction error energy for the updated window (the “new prediction error energy”). The new prediction error energy is determined as a function of the speech signal and the updated window using an autocorrelation method. The autocorrelation method includes relating the new prediction error energy to the autocorrelation values of the speech signal which has been windowed by the updated window to obtain “updated autocorrelation values.” The updated autocorrelation values are defined by the equation:

$${R}^{′} [ l , {n}_{o} ] = {\sum }_{k = l}^{N - 1} {w}^{′} [ k , {n}_{o} ] {w}^{′} [ k - l , {n}_{o} ] s [ k ] s [ k - l ] \qquad ( 19 )$$

wherein it is necessary to calculate all N×(M+1) updated autocorrelation values. However, it can easily be shown that, for l=0 to M and nₒ=0 to N−1:

R′[0,nₒ]=R[0]+Δw(2w[nₒ]+Δw)s²[nₒ] (20)

and, for l=1 to M:

R′[l,nₒ]R[l]+Δw(w[nₒ−l]s[nₒ−l]+w[nₒ+l]s[nₒ+l]) s[nₒ] (21)

By using equations (20) and (21) to determine the updated autocorrelation values, calculation efficiency is greatly improved because the updated autocorrelation values are built upon the results from equation (9) which correspond to the original window.

The stop procedure 127 includes determining whether a threshold is met 132, and if the threshold is not met, repeating steps 126 through 132 until the threshold is met. Determining whether a threshold is met 132 includes comparing the derivatives of the PEEN obtained for the updated window wₘ[nₒ] with those of the previous window wₘ₋₁[nₒ]. If the difference between wₘ[nₒ] and wₘ₋₁[nₒ] is greater than a previously-defined threshold, the threshold has not been met and the gradient-descent procedure 125 and the stop procedure 127 are repeated until the difference between wₘ[nₒ] and wₘ₋₁[nₒ] is less than or equal to the threshold.

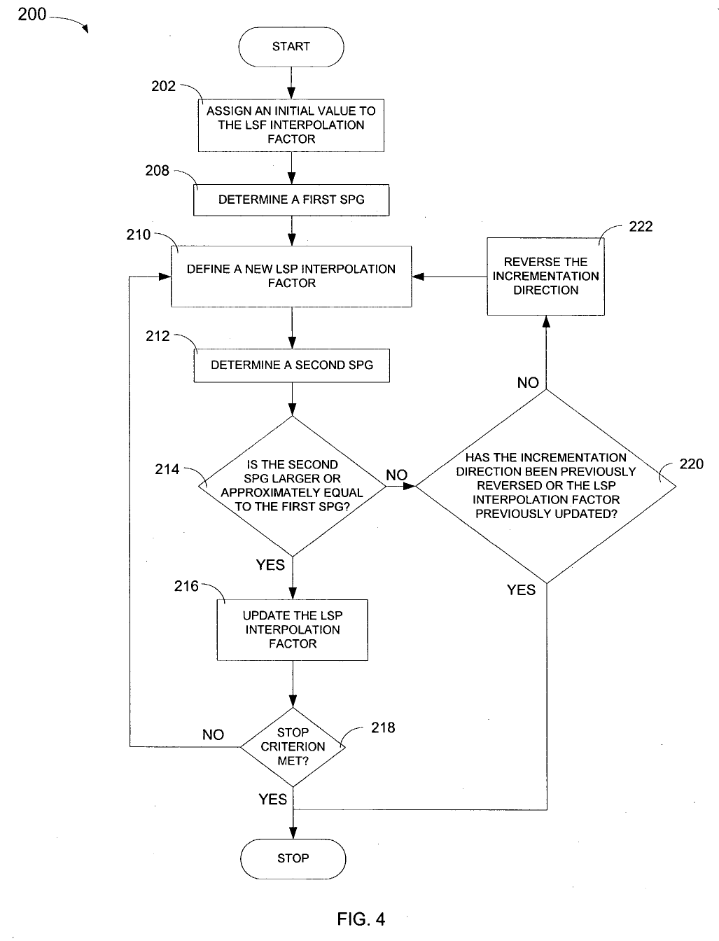

An embodiment of an LSP interpolation factor optimization procedure 200 is shown in FIG. 4. The LSP interpolation factor optimization procedure 200 includes assigning an initial value to the LSP interpolation factor 202; determining a first SPG 208; defining a new LSP interpolation factor 210; determining a second SPG 212; determining whether the second SPG is larger than or approximately equal to the first SPG 214; if the second SPG is not larger or approximately equal to the first SPG, determine whether the incrementation direction had been previously reversed or the LSP interpolation factor had been previously updated 220; reversing the incrementation direction 222 and repeating steps 210, 212, 214, 220 and 222 until it is determined in step 214 that the second SPG is larger than or approximately equal to the first SPG; if it is determined that the second SPG is larger or approximately equal to the first SPG, updating the LSP interpolation factor 216; determining whether a stop criterion has been met 218; if the stop criterion has not been met, repeating steps 210, 212, 214, 220, 222, 216, and 218, as appropriate, until it is determined in step 214 that the stop criterion has been met.

If the LSP interpolation factor optimization procedure 200 is implemented as part of a known speech coding system, assigning an initial value to the LSP interpolation factor 202 generally includes assigning the value for the LSP interpolation factor given by the standard. For example, if the LSP interpolation factor optimization procedure 200 were implemented in the G.729 standard, the initial value assigned to the LSP interpolation factor would be 0.5.

Determining a first SPG 208 includes determining the SPG of the LSP interpolation factor, which has been assigned an initial value in step 202. This generally involves determining PG according to equation (12) which includes determining the ratio of the energy in the speech signal and the energy in the prediction error, which is expressed in decibels (“dB”). PG is calculated for each frame. Therefore, in the G.729 standard, because the frame length is 80 samples, each 80-sample frame has its own PG value. SPG is obtained by averaging the PG values from all the frames, according to the following equation:

$$SPG = \frac{1}{N} {\sum }_{i = o}^{N - 1} {PG}_{i} \qquad ( 22 )$$

where N is the number of frames and each frame has a different PG value.

Defining a new LSP interpolation factor 210 includes incrementing the LSP interpolation factor by a fixed step size in an incrementation direction according to the following equation:

α←α+(STEP)(SIGN) (23)

where SIGN indicates the incrementation direction and STEP is the step of fixed size. The incrementation direction may be either plus or minus one (1 or −1, respectively) and is generally initially set to minus one (−1). STEP may be of any size and will generally be chosen based on speed and accuracy considerations. For example, while a large step size will require fewer interations to reach a final value, the maximum LSP interpolation factor may be missed. In contrast, while a small step size is more likely to increment the LSP interpolation factor to its maximum value, the increased number of iterations required will slow down the determination Determining the second SPG 212 includes determining the SPG associated with the new LSP interpolation factor defined in step 210. Determining whether the second SPG is larger than or approximately equal to the first SPG includes determining whether incrementing the LSP interpolation factor is resulting in an increase in SPG. If the second SPG is not larger than or approximately equal to the prior SPG, step 220 ensures that if the incrementation direction had been previously reversed or the LSP interpolation factor had been previously updated, the process will stop. This will stop the process at the point where the LSP interpolation factor that maximizes the SPG is defined as the LSP interpolation factor, because the new LSP interpolation factor has resulted in a decrease in SPG and either the LSP interpolation factor had already been incremented in both directions, or had reached its optimized value in the first direction. In either case, further incrementations of the LSP interpolation factor in either direction would only result in previously examined values. However, if it is determined in step 220 that the incrementation direction had not previously been reversed, reversing the incrementation direction 216 involves changing the sign of the incrementation direction. Therefore, if the incrementation direction was equal to one, it would be changed to minus one, and vice versa. Subsequently, steps 210, 212, 214, 220 and 222 are repeated until it is determined in step 214 that the second SPG is larger than or approximately equal to the first SPG

Determining whether a stop criterion has been met 218 is performed pursuant to the nature of the stop criterion used. The stop criterion may include the performance of a specified number of iterations, reaching the end of a specified time period or other such criterion. Additionally, the stop criterion (or criteria) may include the SPG reaching saturation. SPG reaches saturation when further increments of the LSP interpolation factor do not yield further increases in SPG. Generally, there need not be exactly no increase in SPG for saturation to be reached. Saturation may be reached if the increase is smaller than a predefined minimum value. The predefined minimum value is generally chosen in view of considerations such as desired computation speed, accuracy and computational load.

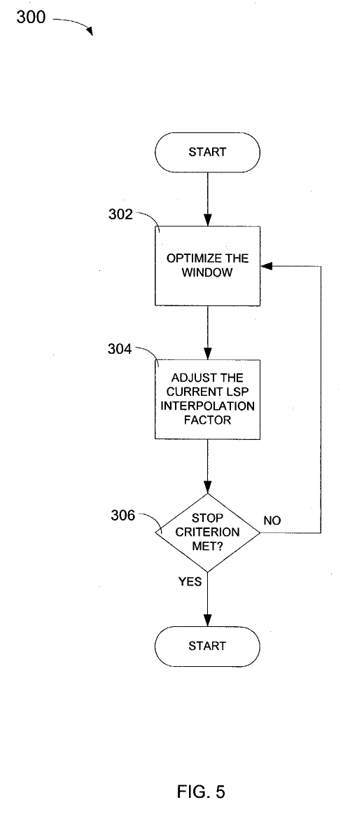

An embodiment of a joint window and interpolation factor optimization procedure 300 is shown in FIG. 5. The joint window and interpolation factor optimization procedure 300 includes optimizing the window 302; adjusting the interpolation factor 304; determining whether a stop criterion has been met 306; and repeating steps 302, 304 and 306 until the stop criterion has been met.

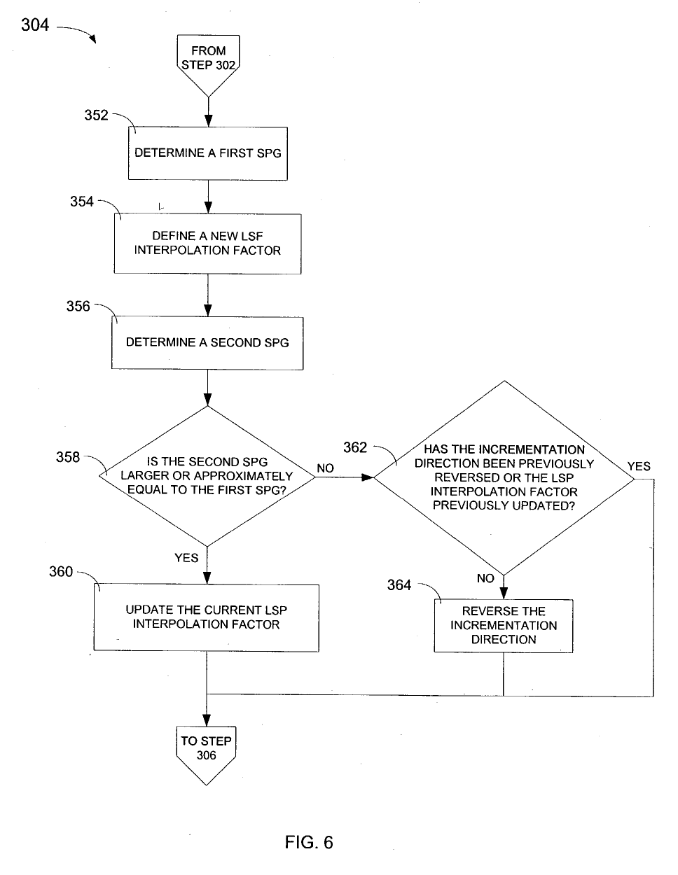

Optimizing the window 302 generally includes assuming an initial value for the LSP interpolation factor to define a current LSP interpolation factor and using current LSP interpolation factor in an alternate window optimization procedure, such as those previously discussed herein in connection with FIG. 3, to optimize the shape of the window. In another embodiment, optimizing the window 302 includes using the current LSP interpolation factor in a primary window optimization procedure. This embodiment may be used to optimize the window and interpolation factor for a speech coding standard such as the ITU-T G.723.1 speech coding standard. Once the window has been optimized in relation to the current LSP interpolation factor, adjusting the current LSP interpolation factor 304 includes using an LSP interpolation factor adjustment procedure, such as the procedure shown in FIG. 6.

The LSP interpolation factor adjustment procedure 304 includes, determining a first SPG 352; defining a new LSP interpolation factor 354; determining a second SPG 356; determining whether the second SPG is larger than or approximately equal to the first SPG 358; where, if the second SPG is not larger than or approximately equal to the first SPG, determining whether the incrementation direction had been previously reversed or the LSP interpolation factor had been previously updated 362, where if the incrementation direction had been previously reversed or the LSP interpolation factor had been previously updated, reversing the incrementation direction 364; where, if the second SPG is not larger than or approximately equal to the first SPG, updating the current LSP interpolation factor.

Determining the first SPG 352 includes determining the SPG of the current LSP interpolation factor. This generally includes determining PG according to equation (12), which includes determining the ratio in decibels of the energy in the speech signal and the energy in the prediction error and determining SPG according to equation (21).

Defining a new LSP interpolation factor 254, includes incrementing the current LSP interpolation factor by a fixed step size in an incrementation direction 354 according to equation (22) where the incrementation direction and the fixed step size are generally, minus-one (−1) and 0.01, respectively. Similarly, determining a second SPG 356 includes, determining the SPG associated with the new LSP interpolation factor in the manner previously described.

Determining whether the second SPG is larger or approximately equal to the first SPG 358 includes determining whether the incrementation of the LSP interpolation factor has resulted in an increase in SPG. If the second SPG is not larger than or approximately equal to the first SPG, determining whether the incrementation direction had been previously reversed or the LSP interpolation factor had been previously updated 362 helps to eliminate the recreation of LSP interpolation factors already examined, as previously discussed. If it is determined that the incrementation direction had been previously reversed or the LSP interpolation factor had been previously updated, the LSP interpolation factor adjustment procedure 304 ends. If, however, it is determined that the incrementation direction had not been previously reversed or the LSP interpolation factor had not been previously updated, reversing the incrementation direction 362 involves changing the sign of the incrementation direction. This allows the search for the optimized LSP interpolation factor to begin with the same current LSP interpolation factor but in the opposite direction following the next optimization of the window in step 302 (FIG. 5).However, if it is determined in step 358 that the second SPG is larger than or approximately equal to the first SPG, updating the current LSP interpolation factor allows the search for the optimized LSP interpolation factor to resume in the same direction starting with the incremented LSP interpolation factor direction following the next optimization of the window in step 302 (FIG. 5).

Returning to FIG. 5, after steps 360 or 364 in FIG. 6 have been completed, a determination is made as to whether a stop criterion has been met 306. As discussed in relation to an LSP interpolation factor optimization procedure, the stop criteria may be the saturation of the SPG. The SPG is saturated when the difference between the SPG associated with the current LSP interpolation factor and the SPG associated with the incremented LSP interpolation factor is zero or within a predefined minimum value. If it is determined that the stop criterion has not been met in step 306, the shape of the window is optimized using the current value for the LSP interpolation factor

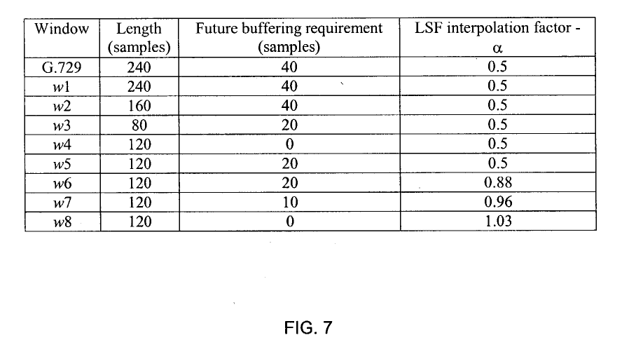

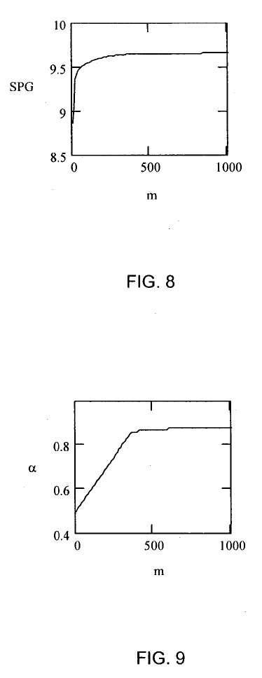

Optimized windows and optimized LSP interpolation factors have been developed using alternate window optimization procedures and joint window and interpolation factor optimization procedures the characteristics of which are summarized in FIG. 7. Windows w1 through w5 were optimized using an alternate window optimization procedure and w6 through w8 were optimized along with the LSP interpolation factor using a joint window and interpolation factor optimization procedure. Both the alternate window optimization procedure and the joint window interpolation factor optimization procedures were used to optimize the G.729 window by using the G.729 window as the initial window and optimized the G.729 LSP interpolation factor of 0.5 by using the G.729 LSP interpolation factor of 0.5 as the initial value for the LSP interpolation factor. The training data set used to create these windows was created using 54 files from the TIMIT database downsampled to 8 kHz with a total duration of approximately three minutes. A total of 1000 training epochs were performed using a perturbation Δw for the gradient-descent of 10⁻¹⁰. Both SPG and optimized LSP interpolation factor (for w6 through w8) tended to saturate during training. An example of this saturation is shown in FIG. 8 and FIG. 9 which show the SPG and optimized LSP interpolation factor, respectively, for w6.

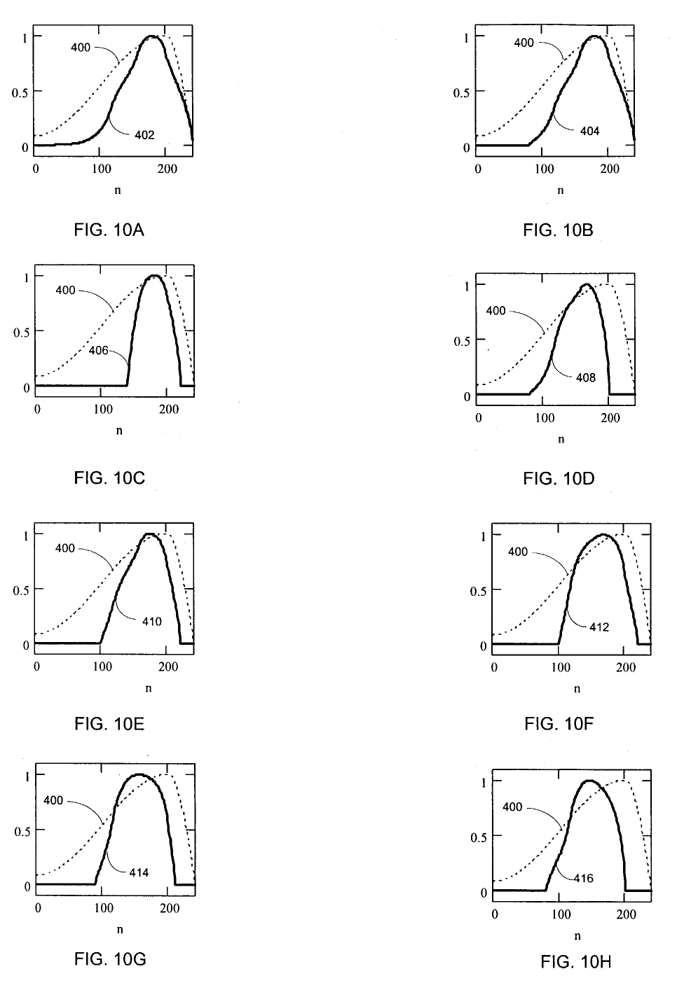

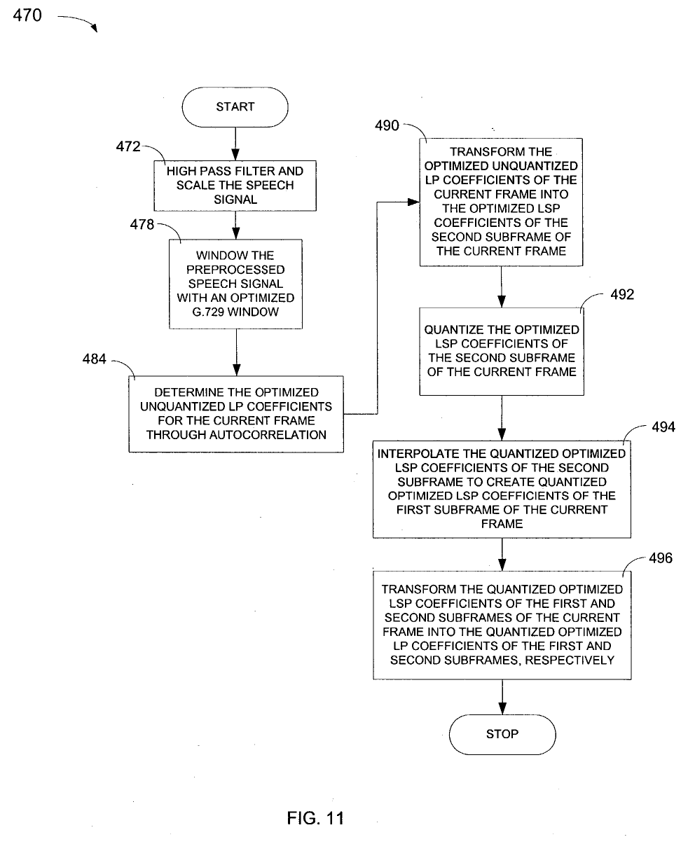

FIG. 10A shows a G.729 window 400 and the optimized G.729 window created by an alternate window optimization procedure w1 402. As indicated in FIG. 7, w1 has the same length (240 samples) and future buffering requirement (40 samples) as the G.729 window. Sample values of w1, for n=0 to 239 are given below:

$$w 1 [ n ] = \{ - 0.000237 , - 0.000459 , - 0.000649 , - 0.000732 , - 0.000810 , - 0.000869 , - 0.000963 , - 0.001035 , - 0.001105 , - 0.001133 , - 0.001164 , - 0.001172 , - 0.001199 , - 0.001220 , - 0.001224 , - 0.001189 , - 0.001173 , - 0.001170 , - 0.001171 , - 0.001129 , - 0.001084 , - 0.001020 , - 0.000961 , - 0.000868 , - 0.000791 , - 0.000732 , - 0.000672 , - 0.000578 , - 0.000498 , - 0.000389 , - 0.000270 , - 0.000155 , - 0.000082 , 0.000036 , 0.000179 , 0.000366 , 0.000547 , 0.000777 , 0.000966 , 0.001163 , 0.001429 , 0.001704 , 0.002034 , 0.002442 , 0.002768 , 0.003009 , 0.003316 , 0.003736 , 0.004208 , 0.004593 , 0.005027 , 0.005572 , 0.006214 , 0.006862 , 0.007512 , 0.008072 , 0.008762 , 0.009537 , 0.010259 , 0.010780 , 0.011326 , 0.012035 , 0.012984 , 0.014061 , 0.015185 , 0.016201 , 0.017164 , 0.018104 , 0.019315 , 0.020451 , 0.021626 , 0.022905 , 0.024416 , 0.025818 , 0.027392 , 0.029275 , 0.031447 , 0.033451 , 0.035310 , 0.037503 , 0.040073 , 0.042859 , 0.045619 , 0.048478 , 0.051622 , 0.055232 , 0.058549 , 0.062056 , 0.066313 , 0.071063 , 0.075693 , 0.079987 , 0.084691 , 0.089954 , 0.095469 , 0.101106 , 0.106946 , 0.113332 , 0.119882 , 0.127238 , 0.134548 , 0.141031 , 0.149027 , 0.158435 , 0.168282 , 0.178534 , 0.188088 , 0.197224 , 0.207630 , 0.218278 , 0.229549 , 0.242790 , 0.257393 , 0.272263 , 0.287628 , 0.302727 , 0.320260 , 0.338398 , 0.356662 , 0.375756 , 0.391461 , 0.402353 , 0.411523 , 0.426919 , 0.442097 , 0.457125 , 0.470478 , 0.482690 , 0.493665 , 0.505192 , 0.515466 , 0.524067 , 0535684 , 0.547782 , 0.559191 , 0.567584 , 0.575941 , 0.586021 , 0.594891 , 0.603359 , 0.610649 , 0.621802 , 0.635396 , 0.648406 , 0.658483 , 0.670266 , 0.681464 , 0.690586 , 0.701875 , 0.713891 , 0.726785 , 0.742499 , 0.759478 , 0.774364 , 0.788681 , 0.804063 , 0.821424 , 0.841290 , 0.859994 , 0.872394 , 0.887378 , 0.904173 , 0.918841 , 0.927554 , 0.934721 , 0.942769 , 0.951851 , 0.957711 , 0.964783 , 0.971730 , 0.977872 , 0.980500 , 0.982293 , 0.985078 , 0.993160 , 0.995710 , 0.997114 , 0.998474 , 1.000000 , 0.997149 , 0.997424 , 0.993460 , 0.989936 , 0.988384 , 0.988770 , 0.985183 , 0.984698 , 0.982134 , 0.978749 , 0.969219 , 0.961557 , 0.952310 , 0.946076 , 0.934954 , 0.924269 , 0.910016 , 0.896763 , 0.878485 , 0.855556 , 0.829415 , 0.806306 , 0.785402 , 0.770519 , 0.760567 , 0.747101 , 0.730306 , 0.713891 , 0.696630 , 0.680546 , 0.665455 , 0.650196 , 0.633707 , 0.618217 , 0.605972 , 0.592923 , 0.578437 , 0.563725 , 0.551464 , 0.538158 , 0.519843 , 0.500879 , 0.486195 , 0.472855 , 0.458538 , 0.440057 , 0.422272 , 0.402885 , 0.383262 , 0.361882 , 0.338678 , 0.316555 , 0.298506 , 0.279068 , 0.255606 , 0.227027 , 0.201944 , 0.174543 , 0.143867 , 0.096811 , 0.044805 \} ;$$

FIG. 10B shows the G.729 window 400 and a second optimized G.729 window created by an alternate window optimization procedure w2 404. As indicated in FIG. 7, w2 has only ⅔ the length (160 samples) of and the same future buffering requirement (40 samples)as the G.729. Sample values of w2, for n=0 to 159 are given below:

$$w 2 [ n ] = \{ 0.005167 , 0.011981 , 0.017841 , 0.022244 , 0.026553 , 0.031068 , 0.035846 , 0.040391 , 0.045182 , 0.050268 , 0.055649 , 0.061057 , 0.066831 , 0.072674 , 0.078826 , 0.085156 , 0.091575 , 0.098293 , 0.105681 , 0.113773 , 0.121601 , 0.129022 , 0.138047 , 0.148204 , 0.158398 , 0.169204 , 0.179212 , 0.188430 , 0.198946 , 0.210257 , 0.222133 , 0.236050 , 0.251162 , 0.266475 , 0.282524 , 0.298583 , 0.315814 , 0.334517 , 0.352428 , 0.372199 , 0.388440 , 0.400000 , 0.408924 , 0.424639 , 0.440411 , 0.455531 , 0.469013 , 0.481291 , 0.492587 , 0.504662 , 0.514708 , 0.524576 , 0.535741 , 0.547732 , 0.558973 , 0.567273 , 0.575847 , 0.585113 , 0.594603 , 0.603477 , 0.610688 , 0.621035 , 0.635554 , 0.648061 , 0.658219 , 0.669725 , 0.681601 , 0.691051 , 0.702236 , 0.713983 , 0.726843 , 0.742869 , 0.760467 , 0.776139 , 0.790253 , 0.805735 , 0.822836 , 0.842261 , 0.861448 , 0.874584 , 0.888622 , 0.905988 , 0.920321 , 0.929926 , 0.935623 , 0.943977 , 0.953429 , 0.959648 , 0.965468 , 0.973359 , 0.978007 , 0.981078 , 0.982898 , 0.985956 , 0.993341 , 0.996419 , 0.997015 , 0.998812 , 1.000000 , 0.997307 , 0.997038 , 0.993513 , 0.990205 , 0.988309 , 0.987577 , 0.984662 , 0.984077 , 0.981707 , 0.978162 , 0.968782 , 0.960647 , 0.952468 , 0.945065 , 0.934680 , 0.923900 , 0.908954 , 0.894633 , 0.878203 , 0.854567 , 0.828177 , 0.804822 , 0.783795 , 0.768115 , 0.758442 , 0.745928 , 0.728510 , 0.712191 , 0.694841 , 0.679219 , 0.663613 , 0.647964 , 0.631325 , 0.616391 , 0.603800 , 0.590816 , 0.575476 , 0.561171 , 0.549193 , 0.535428 , 0.516958 , 0.497337 , 0.482519 , 0.469258 , 0.454658 , 0.436620 , 0.419015 , 0.399476 , 0.379941 , 0.357838 , 0.335101 , 0.313163 , 0.295549 , 0.276211 , 0.253050 , 0.224296 , 0.199336 , 0.172305 , 0.141446 , 0.095822 , 0.043428 \} ;$$

FIG. 10C shows the G.729 window 400 and a third optimized G.729 window created by an alternate window optimization procedure w3 406. As indicated in FIG. 7, w3 has only ¼ the length (80 samples) and only half the future buffering requirement (20 samples) of the G.729 window. Sample values of w3, for n=0 to 79 are given below:

$$w3 [ n ] = \{ 0.070562 , 0.153128 , 0.223865 , 0.277425 , 0.328933 , 0.378871 , 0.428875 , 0.466903 , 0.502980 , 0.540652 , 0.577244 , 0.609723 , 0.642362 , 0.764990 , 0.707747 , 0.736262 , 0.760856 , 0.788273 , 0.816040 , 0.841368 , 0.858992 , 0.873773 , 0.885881 , 0.900523 , 0.915344 , 0.929774 , 0.939798 , 0.950042 , 0.962399 , 0.968204 , 0.970958 , 0.975734 , 0.981824 , 0.986343 , 0.992673 , 0.993414 , 0.995410 , 0.997931 , 1.000000 , 0.999860 , 0.997476 , 0.992981 , 0.991523 , 0.995583 , 0.994843 , 0.992621 , 0.988573 , 0.981661 , 0.976992 , 0.970282 , 0.957811 , 0.945250 , 0.935463 , 0.924735 , 0.911861 , 0.894891 , 0.875673 , 0.853912 , 0.829581 , 0.800928 , 0.772311 , 0.746186 , 0.723912 , 0.699601 , 0.673284 , 0.644950 , 0.615699 , 0.583216 , 0.549339 , 0.516426 , 0.483577 , 0.449650 , 0.417677 , 0.384197 , 0.342482 , 0.299194 , 0.251046 , 0.203717 , 0.143021 , 0.065645 \} ;$$

FIG. 10D shows the G.729 window 400 and a fourth optimized G.729 window created by an alternate window optimization procedure w4 408. As indicated in FIG. 7, w4 has only half the length of the G.729 window (120 samples) and no future buffering is required. Sample values of w4, for n=0 to 119 are given below:

$$w4 [ n ] = \{ 0.006415 , 0.014344 , 0.020862 , 0.026466 , 0.032741 , 0.038221 , 0.043563 , 0.049250 , 0.055802 , 0.061948 , 0.068462 , 0.075503 , 0.082891 , 0.091060 , 0.099387 , 0.107183 , 0.115549 , 0.125696 , 0.136339 , 0.145789 , 0.153726 , 0.164265 , 0.177223 , 0.190620 , 0.203830 , 0.218639 , 0.233720 , 0.249049 , 0.265556 , 0.283663 , 0.301964 , 0.321712 , 0.342502 , 0.366081 , 0.387070 , 0.409486 , 0.433703 , 0.459761 , 0.484018 , 0.506433 , 0.529354 , 0.554275 , 0.573650 , 0.588944 , 0.604544 , 0.625227 , 0.643944 , 0.657806 , 0.671353 , 0.685982 , 0.698897 , 0.711467 , 0.725355 , 0.741354 , 0.756273 , 0.765480 , 0.775370 , 0.784991 , 0.794184 , 0.803647 , 0.813314 , 0.820924 , 0.828048 , 0.837550 , 0.847912 , 0.859458 , 0.864498 , 0.872769 , 0.881746 , 0.887154 , 0.893044 , 0.903660 , 0.911780 , 0.921050 , 0.929696 , 0.938064 , 0.948338 , 0.962459 , 0.971763 , 0.981208 , 0.985637 , 0.988682 , 0.989031 , 0.992217 , 0.994877 , 0.997749 , 1.000000 , 0.997620 , 0.992235 , 0.989169 , 0.983648 , 0.977653 , 0.971034 , 0.965202 , 0.956660 , 0.947502 , 0.935108 , 0.925332 , 0.914033 , 0.898499 , 0.878527 , 0.863358 , 0.849252 , 0.832491 , 0.810874 , 0.788575 , 0.762177 , 0.731820 , 0.699031 , 0.663705 , 0.627703 , 0.592690 , 0.556744 , 0.514179 , 0.461483 , 0.407341 , 0.345522 , 0.281674 , 0.196834 , 0.091395 \} ;$$

FIG. 10E shows the G.729 window 400 and a fifth optimized G.729 window created by an alternate window optimization procedure w5 410. As indicated in FIG. 7, w5 has only half the length (120 samples) and only half the future buffering requirement (20 samples) of the G.729 window. Sample values of w5, for n=0 to 119 are given below:

$$w5 [ n ] = \{ 0.018978 , 0.041846 , 0.060817 , 0.076819 , 0.093595 , 0.108198 , 0.122666 , 0.138033 , 0.154986 , 0.171591 , 0.189209 , 0.207549 , 0.226215 , 0.245981 , 0.266572 , 0.284281 , 0.304491 , 0.328674 , 0.351175 , 0.367542 , 0.380520 , 0.399448 , 0.420786 , 0.437700 , 0.453915 , 0.472322 , 0.489550 , 0.503780 , 0.518673 , 0.530716 , 0.543991 , 0.558394 , 0.574137 , 0.587292 , 0.598577 , 0.610690 , 0.622885 , 0.634574 , 0.644980 , 0.655282 , 0.669466 , 0.686476 , 0.700466 , 0.709844 , 0.719805 , 0.733387 , 0.745502 , 0.754031 , 0.764355 , 0.778127 , 0.789710 , 0.799068 , 0.812027 , 0.827640 , 0.844369 , 0.857770 , 0.869695 , 0.886236 , 0.906606 , 0.924391 , 0.934815 , 0.943317 , 0.948257 , 0.955726 , 0.965829 , 0.975723 , 0.980533 , 0.985198 , 0.992322 , 0.994076 , 0.992745 , 0.993815 , 0.994970 , 0.996295 , 1.000000 , 0.997513 , 0.996372 , 0.997335 , 0.994443 , 0.990290 , 0.985497 , 0.978662 , 0.972400 , 0.972717 , 0.969570 , 0.964077 , 0.957477 , 0.949231 , 0.940475 , 0.930178 , 0.915011 , 0.899944 , 0.887190 , 0.874297 , 0.859036 , 0.838769 , 0.817087 , 0.792972 , 0.765056 , 0.733384 , 0.701939 , 0.673224 , 0.649277 , 0.625261 , 0.598574 , 0.570586 , 0.541216 , 0.510761 , 0.478517 , 0.447402 , 0.416432 , 0.385819 , 0.356005 , 0.325158 , 0288197 , 0.252122 , 0.212228 , 0.171692 , 0.119241 , 0.053863 \} ;$$

FIG. 10F shows the G.729 window 400 and a sixth optimized G.729 window created by a joint window and interpolation factor optimization procedure w6 412. Due to the joint optimization of the window and the interpolation factor, w6 has to be deployed with an optimized LSP interpolation factor of α=0.88. As indicated in FIG. 7, w6 has only half the length (120 samples) and only half the future buffering requirement (20 samples) of the G.729 window. Sample values of w6, for n=0 to 119 are given below:

$$w6 [ n ] = \{ 0.032368 , 0.070992 , 0.104001 , 0.130989 , 0.158618 , 0.183311 , 0.209813 , 0235893 , 0.263139 , 0.290663 , 0.319418 , 0.349405 , 0.380787 , 0.413518 , 0.446571 , 0.475812 , 0.508718 , 0.548017 , 0.584584 , 0.607285 , 0.623716 , 0.648710 , 0.673015 , 0.691285 , 0.710126 , 0.730009 , 0.748768 , 0.763481 , 0.778534 , 0.790593 , 0.803461 , 0.814148 , 0.826917 , 0.836676 , 0.844328 , 0.853257 , 0.862934 , 0.870774 , 0.876733 , 0.883246 , 0.892043 , 0.903228 , 0.911752 , 0.916944 , 0.922037 , 0.928852 , 0.934055 , 0.937002 , 0.941260 , 0.947170 , 0.949587 , 0.950625 , 0.955168 , 0.960953 , 0.968763 , 0.972807 , 0.973065 , 0.976498 , 0.982413 , 0.986591 , 0.988961 , 0.989838 , 0.989248 , 0.9922486 , 0.995513 , 0.998614 , 0.999549 , 1.000000 , 0.999652 , 0.997571 , 0.992708 , 0.988906 , 0.987096 , 0.985167 , 0.986103 , 0.982236 , 0.978635 , 0.977097 , 0.973180 , 0.967504 , 0.960993 , 0.951541 , 0.942105 , 0.941105 , 0.939154 , 0.932846 , 0.923188 , 0.912594 , 0.903162 , 0.891309 , 0.874549 , 0.857906 , 0.843536 , 0.829542 , 0.813114 , 0.791248 , 0.766908 , 0.736502 , 0.699416 , 0.659532 , 0.621899 , 0.586649 , 0.559063 , 0.531663 , 0.502472 , 0.473266 , 0.443670 , 0.413039 , 0.382995 , 0.354757 , 0.327742 , 0.301987 , 0.275724 , 0.248407 , 0.217190 , 0.187928 , 0.157322 , 0.127304 , 0.087168 , 0.038800 \} ;$$

FIG. 10G shows the G.729 window 400 and a seventh optimized G.729 window created by a joint window and interpolation factor optimization procedure w7 414. Due to the joint optimization of the window and the interpolation factor, w7 has to be deployed with an optimized LSP interpolation factor of α=0.96.

As indicated in FIG. 7, w7 has only half the length (120 samples) and only ¼ the future buffering requirement (10 samples) of the G.729 window. Sample values of w7, for n=0 to 119 are given below:

$$w7 [ n ] = \{ 0.022638 , 0.049893 , 0.073398 , 0.091759 , 0.110170 , 0.126403 , 0.143979 , 0.161140 , 0.178336 , 0.194547 , 0.211645 , 0.231052 , 0.251342 , 0.271996 , 0.292451 , 0.312423 , 0.333549 , 0.355545 , 0.376768 , 0.396785 , 0.417081 , 0.442956 , 0.473160 , 0.502298 , 0.530133 , 0.558464 , 0.590280 , 0.624473 , 0.662582 , 0.692886 , 0.712825 , 0.733828 , 0.751837 , 0.770836 , 0.787658 , 0.805155 , 0.820733 , 0.834659 , 0.845647 , 0.855709 , 0.866900 , 0.882317 , 0.895480 , 0.905044 , 0.913294 , 0.923179 , 0.930585 , 0.937805 , 0.945655 , 0.953583 , 0.958026 , 0.961559 , 0.964647 , 0.971273 , 0.980345 , 0.983826 , 0.984393 , 0.986661 , 0.988407 , 0.990593 , 0.992878 , 0.992387 , 0.993311 , 0.995638 , 0.996021 , 0.997546 , 1.000000 , 0.999479 , 0.998087 , 0.995468 , 0.992561 , 0.991342 , 0.989436 , 0.987899 , 0.988164 , 0.985124 , 0.982922 , 0.983393 , 0.977788 , 0.974029 , 0.969894 , 0.964447 , 0.958461 , 0.957896 , 0.955135 , 0.951701 , 0.946896 , 0.939734 , 0.933706 , 0.928074 , 0.919777 , 0.909893 , 0.900927 , 0.892969 , 0.883315 , 0.871214 , 0.859219 , 0.848186 , 0.834842 , 0.817133 , 0.796229 , 0.778367 , 0.762923 , 0.743623 , 0.719600 , 0.694968 , 0.664921 , 0.625471 , 0.578317 , 0.527732 , 0.480384 , 0.438591 , 0.402137 , 0.362915 , 0.316804 , 0.271267 , 0.224062 , 0.178894 , 0.121786 , 0.054482 \} ;$$

FIG. 10H shows the G.729 window 400 and an eighth optimized G.729 window created by a joint window and interpolation factor optimization procedure w8 416. Due to the joint optimization of the window and the interpolation factor, w8 has to be deployed with an LSP interpolation factor of α=1.03. As shown in FIG. 7, w8 has only half the length (120 samples) and of the G.729 window and no future buffering requirement. Sample values of w8, for n=0 to 119 are given below:

$$w8 [ n ] = \{ 0.020460 , 0.045083 , 0.066383 , 0.083309 , 0.100691 , 0.116443 , 0.132084 , 0.146273 , 0.160321 , 0.174568 , 0.189298 , 0.203568 , 0.217862 , 0.232409 , 0.247273 , 0.260606 , 0.273681 , 0.286389 , 0.300298 , 0.312947 , 0.324128 , 0.338319 , 0.356184 , 0.372224 , 0.388061 , 0.404936 , 0.422500 , 0.438661 , 0.458192 , 0.478784 , 0.500707 , 0.525751 , 0.552009 , 0.579318 , 0.604901 , 0.632992 , 0.663769 , 0.697784 , 0.729886 , 0.755063 , 0.775634 , 0.801067 , 0.820260 , 0.835611 , 0.847438 , 0.863815 , 0.880576 , 0.893437 , 0.904934 , 0.917732 , 0.927039 , 0.936925 , 0.945466 , 0.955971 , 0.966724 , 0.972415 , 0977788 , 0.983337 , 0.987107 , 0.989729 , 0.993216 , 0.993077 , 0.993032 , 0.993864 , 0.994757 , 0.995481 , 0.998028 , 1.000000 , 0.999625 , 0.994891 , 0.991095 , 0.989700 , 0.987494 , 0.983622 , 0.979496 , 0.974914 , 0.970786 , 0.968301 , 0.961302 , 0.953409 , 0.946868 , 0.939263 , 0.930691 , 0.927281 , 0.923373 , 0.917657 , 0.912348 , 0.902403 , 0.892379 , 0.883578 , 0.875732 , 0.864583 , 0.854513 , 0.846606 , 0.837772 , 0.826760 , 0.816543 , 0.807560 , 0.796882 , 0.779644 , 0.760555 , 0.745676 , 0.733771 , 0.718454 , 0.699926 , 0.679620 , 0.656820 , 0.631938 , 0.604826 , 0.574119 , 0.543804 , 0.516049 , 0.488212 , 0.453966 , 0.408583 , 0.364608 , 0.314635 , 0.258365 , 0.179497 , 0.084086 \} ;$$

In addition, any window with samples that are approximately within a distance d=0.0001 of any of the optimized G.729 windows will yield comparable results and thus will also be considered an optimized 729 window. Therefore, for example, w1 includes not only the window defined by the sample values given herein, but also all windows with sample values that are approximately within a distance d=0.0001 of those sample values. Likewise, w2, w3, w4, w5, w6, w7 and w8 include not only the window defined by the sample values given herein for, w2, w3, w4, w5, w6, w7 and w8, respectively, but also all windows with sample values that are approximately within a distance d=0.0001 of those sample values, respectively. For the purpose of determining which windows yield comparable results, the distance between two windows d(wa,wb) is defined according to the following equation:

$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} \qquad ( 23 )$$

where wa equals w1, w2, w3, w4, w5, w6, w7 or w8, n and k are sample indices and, N is the number of samples.

The G.729 LPA procedure can be improved through the use of any of one of the alternate window optimization procedures, LSP interpolation factor optimization procedures and joint window and interpolation factor optimization procedures to create an improved G.729 LPA procedure. In one embodiment, the G.729 LPA procedure is improved by replacing the G.729 window with an optimized G.729 window. The optimized G.729 window is used to window the preprocessed speech signal into frames so that optimized unquantized and optimized quantized LP coefficients can be determined for each frame. An embodiment of an improved G.729 LPA procedure 470 is shown in FIG. 11. This improved LPA procedure 470 is similar to the LPA process shown in FIG. 2, except that the window used to break up the preprocessed speech signal into frames is an optimized G.729 window. This embodiment of an improved LPA procedure 470 generally includes: high pass filtering and scaling the speech signal 472, windowing the preprocessed speech signal with an optimized G.729 window 478; determining the optimized unquantized LP coefficients for the current frame using autocorrelation 484; transforming the optimized unquantized LP coefficients of the current frame into the optimized LSP coefficients of the second subframe of the current frame 490, quantizing the optimized LSP coefficients of the second subframe of the current frame 492; interpolating the quantized optimized LSP coefficients of the second subframe to create the quantized optimized LSP coefficients of the first subframe of the current frame 494; and transforming the quantized optimized LSP coefficients of the first and second subframes into the optimized quantized LP coefficients of the first and second frames, respectively 496. The entire procedure is repeated for each frame of the preprocessed speech signal. Alternatively, each step, after the step of high pass filtering and scaling the speech signal 472, may be performed for every frame of speech, one after the other.

Another embodiment of the improved LPA procedure includes a procedure similar to that of the LPA procedure shown in FIG. 2, except that in step 22 the G.729 LSP interpolation factor is replaced with an optimized G.729 LSP interpolation factor and the quantized LSP coefficients of the second subframes are optimally interpolated. Yet another embodiment of an improved G.729 LPS procedure includes a procedure similar to that of the G.729 LPA procedure shown in FIG. 9, except that in step 494 the G.729 LSP interpolation factor is replaced with an optimized G.729 LSP interpolation factor and the quantized LSP coefficients of the second subframes are optimally interpolated.

Additionally, all the embodiments of the improved LPA procedures may be substituted for the G.729 LPA procedures in the G.729 standard to yield an improved G.729 standard. To assess the improvement in subjective quality achieved by the improved G.729 standard over the G.729 standard, the PESQ scores (which are a measure of the subjective quality of a synthesized speech signal as set forth in the recent ITU-T P.862 perceptual evaluation of speech quality (PESQ) standard described in ITU, “Perceptual Evaluation of Speech Quality (PESQ), An Objective Method for End-to-End Speech Quality Assessment of Narrow-Band Telephone Networks and Speech Codecs—ITU-T Recommendation P.862,” Pre-publication, 2001; and Opticom, OPERA: “Your Digital Ear!—User Manual, Version 3.0, 2001”) for a variety of improved G.729 standard-based systems using a variety of improved LPA procedures were determined. In addition to the G.729 standard, eight improved G.729 standards were implemented for comparison. The differences among the G.729 standard and the improved G.729 standards were in the LPA procedures, number of window samples, future buffering requirements and LSP interpolation factors. The characteristics of the windows used in the G.729 standard (the G.729 window) and the improved G.729 standards (w1 through w8) are summarized in FIG. 7.

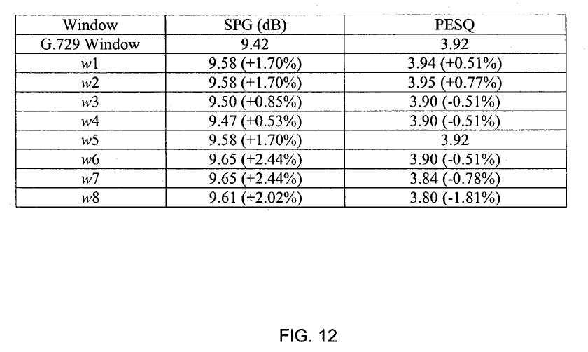

The table shown in FIG. 12 summarizes the SPG and PESQ scores for the G.729 standards and the improved G.729 standards. The numbers in parenthesis indicate the percentage of improvement in the score over that obtained by the G.729 standard. In general, all the improved G.729 standards achieved a higher SPG score than did the G.729 standard while maintaining the subjective quality (as indicated by PESQ) obtained by the G.729 standard to within less than a couple of percentage points. Because all the improved G.729 standards, except for that using w1, require a lower number of window samples per frame and, in most cases, have a lower buffering requirement, they can be implemented at a reduced computational cost and, in most cases, with a lower coding delay. Additionally, the improved G.729 standard using w1 or w2 can be implemented in situations that require quality higher subjective quality than the G.729 standard can supply.

Implementations and embodiments of alternate window optimization procedures, LSP interpolation factor optimization procedures, joint window and interpolation factor optimization procedures, optimized G.729 windows, optimized G.729 LSP interpolation factors, improved LPA procedures and improved G.729 standards include computer readable software code. Such code may be stored on a processor, a memory device or on any other computer readable storage medium. Alternatively, the software code may be encoded in a computer readable electronic or optical signal. The code may be object code or any other code describing or controlling the functionality described herein. The computer readable storage medium may be a magnetic storage disk such as a floppy disk, an optical disk such as a CD-ROM, semiconductor memory or any other physical object storing program code or associated data.

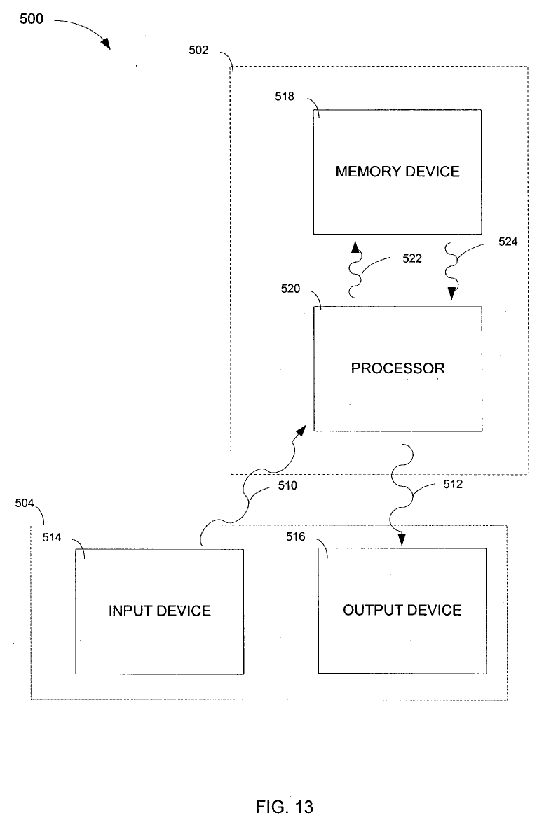

The alternate window optimization procedures, LSP interpolation factor optimization procedures, joint window and LSP interpolation factor optimization procedures, optimized G.729 windows, optimized G.729 LSP interpolation factors, improved LPA procedures and improved G.729 standards may be implemented in an optimization device 500, as shown in FIG. 13, alone or in any combination. The optimization device 500 generally includes an optimization unit 502 and may also include an interface unit 504. The optimization unit 502 includes a processor 520 coupled to a memory device 516. The memory device 518 may be any type of fixed or removable digital storage device and (if needed) a device for reading the digital storage device including, floppy disks and floppy drives, CD-ROM disks and drives, optical disks and drives, hard-drives, RAM, ROM and other such devices for storing digital information. The processor 520 may be any type of apparatus used to process digital information. The memory device 518 may store a speech signal, a G.729 window, a rectangular window, an LSP interpolation factor, at least one optimized window; at least one LSP interpolation factor, at least one LPA procedure, or any combination of the foregoing. Upon the relevant request from the processor 520 via a processor signal 522, the memory communicates the requested information via a memory signal 524 to the processor 520.

The interface unit 504 generally includes an input device 514 and an output device 516. The output device 516 receives information from the processor 520 via a second processor signal 512 and may be any type of visual, manual, audio, electronic or electromagnetic device capable of communicating information from a processor or memory to a person or other processor or memory. Examples of output devices include, but are not limited to, monitors, speakers, liquid crystal displays, networks, buses, and interfaces. The input device 514 communicates information to the processor via an input signal 510 and may be any type of visual, manual, mechanical, audio, electronic, or electromagnetic device capable of communicating information from a person or processor or memory to a processor or memory. Examples of input devices include keyboards, microphones, voice recognition systems, trackballs, mice, networks, buses, and interfaces. Alternatively, the input and output devices 514 and 516, respectively, may be included in a single device such as a touch screen, computer, processor or memory coupled to the processor via a network.

For example, in one embodiment, the optimization device 500 optimizes the window used by the G.729 standard. In this embodiment, the G.729 window or a rectangular window and an alternate window optimization procedure are stored in the memory device 518. Training data may then be input into the memory device 518 by entering the training data into the input device 514. The input device 514 then communicates the training data to the processor via the input signal 510, where the processor 520 communicates the training data to the memory device 518 via processor signal 522. In response to a request that may come from the input device 514, the processor 520 requests the alternate window optimization routine from the memory device 518 via the processor signal 522 and the memory. The processor 520 makes another request to the memory device 518 for the G.729 window or a rectangular window. After the memory device 518 communicates the window to the processor 520, the processor 520 runs the alternate window optimization routine to produce an optimized G.729 window. The optimized G.729 window may be communicated to the output device 516 via the second processor signal 512 and/or communicated to the memory device 518 via the processor signal 512 for storage. In a similar manner, the optimization device may be used to optimize an LSP interpolation factor or jointly optimize the window and LSP interpolation factor. Furthermore, the optimization device may be used to implement an improved G.729 standard.

Although the methods and apparatuses disclosed herein have been described in terms of specific embodiments and applications, persons skilled in the art can, in light of this teaching, generate additional embodiments without exceeding the scope or departing from the spirit of the claimed invention.

What is claimed is:

1. A method for improving a linear predictive analysis procedure for a G.729 standard to create an improved G.729 standard, wherein the linear predictive analysis procedure comprises windowing a preprocessed speech signal with a G.729 window, comprising:
replacing the window with an improved G.729 window; and
using the improved G.729 window to window the preprocessed speech signal.

2. The method, as claimed in claim 1, wherein the optimized window comprises an optimized window created by an alternate window optimization procedure.

3. The method, as claimed in claim 2, wherein the optimized window comprises a window w1.

4. The method, as claimed in claim 2, wherein the optimized window comprises a window w2.

5. The method, as claimed in claim 2, wherein the optimized window comprises a window w3.

6. The method, as claimed in claim 5, wherein the G.729 standard further comprises a future buffering requirement of 40 samples; and wherein the method further comprises reducing the future buffering requirement to approximately 20 samples.

7. The method, as claimed in claim 2, wherein the optimized window comprises a window w4.

8. The method, as claimed in claim 7, wherein the G.729 standard further comprises a future buffering requirement of 40 samples; and wherein the method further comprises reducing the future buffering requirement to approximately zero samples.

9. The method, as claimed in claim 2, wherein the optimized window comprises a window w5.

10. The method, as claimed in claim 9, wherein the G.729 standard further comprises a future buffering requirement of 40 samples; and wherein the method further comprises reducing the future buffering requirement to approximately 20 samples.

11. The method, as claimed in claim 1, wherein the G.729 standard further comprises an LSP interpolation factor and the method further comprising replacing the LSP interpolation factor with an optimized LSP interpolation factor.

12. The method, as claimed in claim 11, wherein the optimized window comprises a window w6 and the optimized LSP interpolation factor is 0.88.

13. The method, as claimed in claim 12, wherein the G.729 standard further comprises a future buffering requirement of 40 samples; and wherein the method further comprises reducing the future buffering requirement to approximately 20 samples.

14. The method, as claimed in claim 11, wherein the optimzed window comprises a window w7 and the optimized LSP interpolation factor is 0.96.

15. The method, as claimed in claim 14, wherein the G.729 standard further comprises a future buffering requirement of 40 samples; and wherein the method further comprises reducing the future buffering requirement to approximately 10 samples.

16. The method, as claimed in claim 11, wherein the optimized window comprises a window w8 and the optimized LSP interpolation factor is 1.03.

17. The method, as claimed in claim 16, wherein the G.729 standard further comprises a future buffering requirement of 40 samples; and wherein the method further comprises reducing the future buffering requirement to approximately zero samples.

18. A method for improving a linear predictive analysis procedure for a G.729 standard to create an improved G.729 standard, wherein the linear predictive analysis procedure interpolates a plurality of quantized LSP coefficients using an LSP interpolation factor, comprising:
replacing the LSP interpolation factor with an optimized LSP interpolation factor; and
using the optimized LSP interpolation factor to interpolate the plurality of quantized LSP coefficients.

19. The method, as claimed in claim 18, wherein the optimized LSP interpolation factor comprises an optimized LSP interpolation factor created by an LSP interpolation factor optimization procedure.

20. The method, as claimed in claim 19, wherein the optimized LSP interpolation factor is 0.88.

21. The method, as claimed in claim 19, wherein the optimized LSP interpolation factor is 0.96.

22. The method, as claimed in claim 19, wherein the optimized LSP interpolation factor is 1.03.

23. An improved linear prediction analysis procedure for a G.729 standard, comprising:
(A) high pass filtering and scaling a speech signal to create a preprocessed speech signal, wherein the preprocessed speech signal comprises a plurality of segments;
(B) windowing the preprocessed speech signal with an optimized G.729 window to create a frame of the preprocessed speech signal, wherein the frame comprises one of the plurality of segments of the preprocessed speech signal and includes a first subframe and a second subframe;
(C) determining a plurality of optimized unquantized LP coefficients for the frame through autocorrelation;
(D) transforming the plurality of optimized unquantized LP coefficients for the frame into optimized LSP coefficients for the second subframe of the frame;
(E) quantizing the plurality of optimized LSP coefficients for the second frame of the frame to create quantized optimized LSP coefficients for the second frame of the frame;
(F) interpolating the quantized optimized LSP coefficients for the second frame of the frame with optimized LSP coefficients for a second frame of a prior frame to create quantized optimized LSP coefficients of the first subframe of the frame;
(G) transforming the quantized optimized LSP coefficients of the first and second subframes of the frame into quantized optimized LP coefficients of the first and second subframes, respectively; and
(H) repeating steps (B) through (G) for each of the plurality of segments of the preprocessed speech signal.

24. The improved linear prediction analysis procedure, as claimed in claim 23, wherein the optimized G.729 window comprises an optimized G.729 window created by an alternate window optimization procedure.

25. The improved linear prediction analysis procedure, as claimed in claim 23, wherein the optimized G.729 window comprises a window w1.

26. The improved linear prediction analysis procedure, as claimed in claim 23, wherein the optimized G.729 window comprises a window w2.

27. The improved linear prediction analysis procedure, as claimed in claim 23, wherein the optimized G.729 window comprises a window w3.

28. The improved linear prediction analysis procedure, as claimed in claim 27, wherein the improved linear prediction analysis further comprises a future buffering requirement of approximately 20 samples.

29. The improved linear prediction analysis procedure, as claimed in claim 23, wherein the optimized G.729 window comprises a window w4.

30. The improved linear prediction analysis procedure, as claimed in claim 27, wherein the improved linear prediction analysis further comprises a future buffering requirement of approximately zero samples.

31. The improved linear prediction analysis procedure, as claimed in claim 23, wherein the optimized G.729 window comprises a window w5.

32. The improved linear prediction analysis procedure, as claimed in claim 31, wherein the improved linear prediction analysis further comprises a future buffering requirement of approximately 20 samples.

33. The improved linear prediction analysis procedure, as claimed in claim 23, wherein interpolating the quantized optimized LSP coefficients comprises interpolating the quantized optimized LSP coefficients with an optimized LSP interpolation factor.

34. The improved linear prediction analysis procedure, as claimed in claim 33, wherein the optimized G.729 window comprises a window w6 and the optimized LSP interpolation factor is 0.88.

35. The improved linear prediction analysis procedure, as claimed in claim 34, wherein the improved linear prediction analysis further comprises a future buffering requirement of approximately 20 samples.

36. The improved linear prediction analysis procedure, as claimed in claim 33, wherein the optimized G.729 window comprises a window w7 and the optimized LSP interpolation factor is 0.96.

37. The improved linear prediction analysis procedure, as claimed in claim 36, wherein the improved linear prediction analysis further comprises a future buffering requirement of approximately 10 samples.

38. The improved linear prediction analysis procedure, as claimed in claim 33, wherein the optimized G.729 window comprises a window w8 and the optimized LSP interpolation factor is 1.03.

39. The improved linear prediction analysis procedure, as claimed in claim 38, wherein the improved linear prediction analysis further comprises a future buffering requirement of approximately zero samples.

40. An improved G.729 standard, comprising:
the steps of claims 23, 24, 25, 26, 27, 28, 29, 30, 31, 32, 33, 34, 35, 36, 37, 38, or 39; and
determining an excitation signal for the frame using the quantized optimized LP coefficients of the first and second subframes of the frame for each of the plurality of segments of the preprocessed speech signal.

41. An alternate window optimization procedure for optimizing a window used to isolate a speech signal into a plurality of frames, comprising:
(A) assuming a window;
(B) determining a window prediction error energy; wherein the window prediction error energy is a prediction error energy associated with the window;
(C) estimating a gradient of the window prediction error energy;
(D) updating the window in a direction negative to the gradient of the widow prediction error energy to create an updated window and to redefine the window with the updated window;
(E) redetermining the window prediction error energy as a function of the window;
(F) determining if a threshold has been reached, wherein if the threshold has not been reached, repeating steps (C), (D), (E) and (F) until the threshold has been met.

42. The alternate window optimization procedure, as claimed in claim 41, wherein determining the window prediction error energy includes using an autocorrelation method.

43. The alternate window optimization procedure, as claimed in claim 41, wherein estimating the gradient of the window prediction error energy includes:
defining an intermediate window;
determining an intermediate prediction error energy; wherein the intermediate prediction error energy is a prediction error energy associated with the intermediate window; and
estimating the gradient of the window prediction error energy as a function of the window prediction error energy and the intermediate prediction error energy.

44. The alternate window optimization procedure, as claimed in claim 43, wherein defining the intermediate window includes defining a plurality of intermediate window samples w′[n] as a function of a first sample index n, a second sample index nₒ, a plurality of window samples w[n], a window perturbation constant Δw, and according to equations w′[n]=w[n], n≠nₒ; w′[nₒ]=w[nₒ]+Δw, n=nₒ.

45. The alternate window optimization procedure, as claimed in claim 44, wherein the window perturbation constant Δw equals from approximately 10⁻⁷ to approximately 10⁻⁴.

46. The alternate window optimization procedure, as claimed in claim 44, wherein estimating the gradient of the window prediction error energy includes estimating a derivative of the window prediction error energy with respect to each of the plurality of window samples according to a basic definition of a derivative.

47. The alternate window optimization procedure, as claimed in claim 46, wherein estimating the derivative of the window prediction error energy with respect to each of the plurality of window samples according to the basic definition of the derivative includes estimating the derivative of the window prediction error energy with respect to each of the plurality of window samples
$$\frac{\partial J}{\partial w [ n ]}$$
as a function of each of the plurality of window samples w[n], the intermediate prediction error energy J′[n], the window perturbation constant Δw, the window prediction error energy, and according to an equation
$$\frac{\partial J}{\partial w [ n ]} \approx \frac{{J}^{'} [ n ] - J}{Δ w} .$$

48. The alternate window optimization procedure, as claimed in claim 41, wherein updating the window in the direction negative to the gradient of the widow prediction error energy to create an updated window and to redefine the window with the updated window includes, creating a sample of the updated window wₘ[n]_{updated} as a function of a sample index n, a window sample wₘ[n], a derivative of the window prediction error energy with respect to the window sample
$$\frac{\partial J}{\partial {w}_{m} [ n ]} ,$$
a step size parameter μ, and according to an equation
$${{w}_{m} [ n ]}_{updated} = {w}_{m} [ n ] - μ \cdot \frac{\partial J}{\partial {w}_{m} [ n ]}$$
for each sample index n; and redefining the window with the updated window includes redefining the window sample wₘ[n] according to an equation wₘ[n]←wₘ[n]_{updated}, for each sample index n.

49. The alternate window optimization procedure, as claimed in claim 48, wherein the step size parameter μ is equal to approximately 10⁻⁹.

50. The alternate window optimization procedure, as claimed in claim 41, wherein redetermining the window prediction error energy as a function of the s window includes determining the window prediction error energy as a function of the window using an autocorrelation method.

51. The alternate window optimization procedure, as claimed in claim 41, wherein assuming a window includes assuming a G.729 window.

52. The alternate window optimization procedure, as claimed in claim 41, wherein assuming a window includes assuming a rectangular window.

53. An LSP interpolation factor optimization procedure for optimizing an LSP interpolation factor, comprising:
(A) assigning an initial value to an LSP interpolation factor;
(B) determining a first SPG, wherein the first SPG is an SPG associated with the LSP interpolation factor;
(C) defining a new LSP interpolation factor by incrementing the LSP interpolation factor by a fixed step size in an incrementation direction;
(D) determining a second SPG, wherein the second SPG is an SPG associated with the new LSP interpolation factor;
(E) determining whether the second SPG is larger than or approximately equal to the first SPG;
wherein if the second SPG is not larger than or approximately equal to the first SPG, repeating determining whether the incrementation direction has been previously reversed or the LSP interpolation factor has been previously updated, reversing the incrementation direction, redefining the new LSP interpolation factor, redetermining the second SPG, and determining whether the second SPG is larger than or approximately equal to the first SPG, until the second SPG is larger than or approximately equal to the first SPG;
wherein if the second SPG is larger than or approximately equal to the first SPG, updating the LSP interpolation factor to equal the new LSP interpolation factor and determining whether a stop criterion has been met;
wherein if the stop criterion has not been met, repeating steps (C), (D) and (E) until the stop criterion has been met.

54. An LSP interpolation factor optimization procedure, as claimed in claim 53, wherein the initial value is approximately 0.5.

55. An LSP interpolation factor optimization procedure, as claimed in claim 53, wherein the fixed step size is approximately 0.01.

56. A joint window and LSP interpolation factor optimization procedure, comprising:
(A) optimizing a window using a window optimization procedure;
(B) adjusting a current LSP interpolation factor to create an adjusted LSP interpolation factor; and
(C) determining whether a stop criterion has been met, wherein if the stop criterion has not been met, repeating steps (A), (B) and (C) until the stop criterion has been met.

57. The method for jointly optimizing the window and the interpolation factor, as claimed in claim 56, wherein the window optimization procedure is a primary window optimization procedure.

58. The method for jointly optimizing the window and the interpolation factor, as claimed in claim 56, wherein the window optimization procedure is an alternate window optimization procedure.

59. The method for jointly optimizing the window and the interpolation factor, as claimed in claim 58, wherein the alternate window optimization procedure comprises:
(A) assuming a window;
(B) determining a window prediction error energy; wherein the window prediction error energy is a prediction error energy associated with the window;
(C) estimating a gradient of the window prediction error energy;
(D) updating the window in a direction negative to the gradient of the widow prediction error energy to create an updated window and to redefine the window with the updated window;
(E) redetermining the window prediction error energy as a function of the window;
(F) determining if a threshold has been reached, wherein if the threshold has not been reached, repeating steps (C), (D), (E) and (F) until the threshold has been met.

60. The method for jointly optimizing the window and the interpolation factor, as claimed in claim 59, wherein determining the window prediction error energy includes using an autocorrelation method.

61. The method for jointly optimizing the window and the interpolation factor, as claimed in claim 59, wherein estimating the gradient of the prediction error energy associated with the perturbed window includes:
defining an intermediate window;
determining an intermediate prediction error energy; wherein the intermediate prediction error energy is a prediction error energy associated with the intermediate window; and
estimating the gradient of the window prediction error energy as a function of the window prediction error energy and the intermediate prediction error energy.

62. The method for jointly optimizing the window and the interpolation factor, as claimed in claim 61, wherein defining the intermediate window includes defining a plurality of intermediate window samples w′[n] as a function of a first sample index n, a second sample index nₒ, a plurality of window samples w[n], a window perturbation constant Δw, and according to equations w′[n]=w[n], n≠nₒ; w′[nₒ]=w[nₒ]+Δw, n=nₒ.

63. The method for jointly optimizing the window and the interpolation factor, as claimed in claim 64, wherein the window perturbation constant Δw equals from approximately 10⁻⁷ to approximately 10⁻⁴.

64. The method for jointly optimizing the window and the interpolation factor, as claimed in claim 61, wherein estimating the gradient of the window prediction error energy includes estimating a derivative of the window prediction error energy with respect to each of the plurality of window samples according to a basic definition of a derivative.

65. The method for jointly optimizing the window and the interpolation factor, as claimed in claim 64, wherein estimating the derivative of the window prediction error energy with respect to each of the plurality of window samples according to the basic definition of the derivative includes estimating the derivative of the window prediction error energy with respect to each of the plurality of window samples
$$\frac{\partial J}{\partial w [ n ]}$$
as a Δw[n] function of each of the plurality of window samples w[n], the intermediate prediction error energy J′[n], the window perturbation constant Δw, the window prediction error energy, and according to an equation
$$\frac{\partial J}{\partial w [ n ]} \approx \frac{{J}^{′} [ n ] - J}{Δ w} .$$

66. The method for jointly optimizing the window and the interpolation factor, as claimed in claim 64, wherein updating the window in the direction negative to the gradient of the widow prediction error energy to create an updated window and to redefine the window with the updated window includes, creating a sample of the updated window wₘ[n]_{updated} as a function of a sample index n, a window sample wₘ[n], a derivative of the window prediction error energy with respect to the window sample
$$\frac{\partial J}{\partial {w}_{m} [ n ]} ,$$
a step size parameter μ, and according to an equation
$${{w}_{m} [ n ]}_{updated} = {w}_{m} [ n ] - μ \cdot \frac{\partial J}{\partial {w}_{m} [ n ]}$$
for each sample index n; and redefining the window with the updated window includes redefining the window sample wₘ[n] according to an equation wₘ[n]←wₘ[n]_{updated}, for each sample index n.

67. The method for jointly optimizing the window and the interpolation factor, as claimed in claim 66, wherein the step size parameter μ is equal to approximately 10⁻⁹.

68. The method for jointly optimizing the window and the interpolation factor, as claimed in claim 67, wherein redetermining the window prediction error energy as a function of the window includes determining the window prediction error energy as a function of the window using an autocorrelation method.

69. The method for jointly optimizing the window and the interpolation factor, as claimed in claim 59, wherein assuming a window includes assuming a G.729 window.

70. The method for jointly optimizing the window and the interpolation factor, as claimed in claim 59, wherein assuming a window includes assuming a rectangular window.

71. The method for jointly optimizing the window and the interpolation factor, as claimed in claim 56, wherein adjusting a current LSP interpolation factor to create an adjusted LSP interpolation factor comprises:
determining a first SPG, wherein the first SPG is an SPG associated with the current LSP interpolation factor;
defining a new LSP interpolation factor by incrementing the current LSP interpolation factor by a fixed step size in an incrementation direction;
determining a second SPG, wherein the second SPG is an SPG associated with the new LSP interpolation factor; and
determining if the second SPG is larger than or approximately equal to the first SPG; wherein if the second SPG is not larger than or approximately equal to the first SPG, determining whether the incrementation direction has been previously reversed or if the LSP interpolation factor had been previously updated; wherein if wherein if the incrementation direction has been previously reversed or if the LSP interpolation factor has been previously updated, resuming the joint window and LSP interpolation factor optimization procedure with step (C); wherein if the incrementation direction has not been previously reversed and if the LSP interpolation factor has not been previously updated, reversing the incrementation direction; and wherein if the second SPG is larger than or approximately equal to the first SPG updating the current LSP interpolation factor to equal the next LSP interpolation factor.

72. The method for jointly optimizing the window and the interpolation factor, as claimed in claim 56, wherein the fixed step size is approximately 0.01.

73. An optimized window for a G.729 speech coding standard comprising a plurality of samples and a plurality of values, wherein each of the plurality of samples n includes one of the plurality of values such that for n=[0,239] the plurality of values comprise w1.

74. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w1, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

75. An optimized window for a G.729 speech coding standard comprising a plurality of samples and a plurality of values, wherein each of the plurality of samples n includes one of the plurality of values such that for n=[0,159] the plurality of values comprise w2.

76. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w2, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

77. An optimized window for a G.729 speech coding standard comprising a plurality of samples and a plurality of values, wherein each of the plurality of samples n includes one of the plurality of values such that for n=[0,79] the plurality of values comprise w3.

78. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w3, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

79. An optimized window for a G.729 speech coding standard comprising a plurality of samples and a plurality of values, wherein each of the plurality of samples n includes one of the plurality of values such that for n=[0,119] the plurality of values comprise w4.

80. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w4, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

81. An optimized window for a G.729 speech coding standard comprising a plurality of samples and a plurality of values, wherein each of the plurality of samples n includes one of the plurality of values such that for n=[0,119] the plurality of values comprise w5.

82. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w5, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

83. An optimized window for a G.729 speech coding standard comprising a plurality of samples and a plurality of values, wherein each of the plurality of samples n includes one of the plurality of values such that for n=[0,119] the plurality of values comprise w6.

84. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w6, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

85. An optimized window for a G.729 speech coding standard comprising a plurality of samples and a plurality of values, wherein each of the plurality of samples n includes one of the plurality of values such that for n=[0,119] the plurality of values comprise w7.

86. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w7, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

87. An optimized window for a G.729 speech coding standard comprising a plurality of samples and a plurality of values, wherein each of the plurality of samples n includes one of the plurality of values such that for n=[0,119] the plurality of values comprise w8.

88. An optimized window for a G.729 speech coding standard comprising, a first plurality of sample values wa, wherein the first plurality of sample values are approximately within a distance d=0.0001 of a window comprising a second plurality of sample values wb, wherein the second plurality of sample values wb comprises w8, and wherein the distance d between wa and wb is defined according to a number of samples N, a first index n, a second index k, and according to an equation:
$$d ( wa , wb ) = {\sum }_{n = 0}^{N - 1} {( \frac{wa [ n ]}{\sqrt{{\sum }_{k = 0}^{N - 1} {wa}^{2} [ k ]}} - \frac{wb [ n ]}{\sqrt{{\sum }_{k = 0}^{N - 1} {wb}^{2} [ k ]}} )}^{2} .$$

89. An optimized LSP interpolation factor for a G.729 speech coding standard wherein the optimized interpolation factor was created using an LSP interpolation factor optimization procedure and has a value of approximately 0.88.

90. An optimized LSP interpolation factor for a G.729 speech coding standard wherein the optimized interpolation factor was created using an LSP interpolation factor optimization procedure and has a value of approximately 0.96.

91. An optimized LSP interpolation factor for a G.729 speech coding standard wherein the optimized interpolation factor was created using an LSP interpolation factor optimization procedure and has a value of approximately 1.03.

92. A computer readable storage medium storing computer readable data comprising an optimized window for use with a linear predictive analysis procedure of an ITU-T G 729 standard, the optimized window comprising a first plurality of sample values, wherein the first plurality of sample values comprises: −0.000237, −0.000459, −0.000649, −0.000732, −0.000810, −0.000869, −0.000963, −0.001035, −0.001105, −0.001133, −0.001164, −0.001172, −0.001199, −0.001220, −0.001224, −0.001189, −0.001173, −0.001170, −0.001171, −0.001129, −0.001084, −0.001020 −0.000961, −0.000868, −0.000791, −0.000732, −0.000672, −0.000578, −0.000498, −0.000389, −0.000270, −0.000155, −0.000082, 0.000036, 0.000179, 0.000366, 0.000547, 0.000777, 0.000966, 0.001163, 0.001429, 0.001704, 0.002034, 0.002442, 0.002768, 0.003009, 0.003316, 0.003736, 0.004208, 0.004593, 0.005027, 0.005572, 0.006214, 0.006862, 0.007512, 0.008072, 0.008762, 0.009537, 0.010259, 0.010780, 0.011326, 0.012035, 0.012984, 0.014061, 0.015185, 0.016201, 0.017164, 0.018104, 0.019315, 0.020451, 0.021626, 0.022905, 0.024416, 0.025818, 0.027392, 0.029275, 0.031447, 0.033451, 0.035310, 0.037503, 0.040073, 0.042859, 0.045619, 0.048478, 0.051622, 0.055232, 0.058549, 0.062056, 0.066313, 0.071063, 0.075693, 0.079987, 0.084691, 0.089954, 0.095469, 0.101106, 0.106946, 0.113332, 0.119882, 0.127238, 0.134548, 0.141031, 0.149027, 0.158435, 0.168282, 0.178534, 0.188088, 0.197224, 0.207630, 0.218278, 0.229549, 0.242790, 0.257393, 0.272263, 0.287628, 0.302727, 0.320260, 0.338398, 0.356662, 0.375756, 0.391461, 0.402353, 0.411523, 0.426919, 0.442097, 0.457125, 0.470478, 0.482690, 0.493665, 0.505192, 0.515466, 0.524607, 0.535684, 0.547782, 0.559191, 0.567584, 0.575941, 0.586021, 0.594891, 0.603359, 0.610649, 0.621802, 0.635396, 0.648406, 0.658483, 0.670266, 0.681464, 0.690586, 0.701875, 0.713891, 0.726785, 0.742499, 0.759478, 0.774364, 0.788681, 0.804063, 0.821424, 0.841290, 0.859994, 0.872394, 0.887378, 0.904173, 0.918841, 0.927554, 0.934721, 0.942769, 0.951851, 0.957711, 0.964783, 0.971730, 0.977872, 0.980500, 0.982293, 0.985078, 0.993160, 0.995710, 0.997114, 0.998474, 1.000000, 0.997149, 0.997424, 0.993460, 0.989936, 0.988384, 0.988770, 0.985183, 0.984698, 0.982134, 0.978749, 0.969219, 0.961557, 0.952310, 0.946076, 0.934954, 0.924269, 0.910016, 0.896763, 0.878485, 0.855556, 0.829415, 0.806306, 0.785402, 0.770519, 0.760567, 0.747101, 0.730306, 0.713891, 0.696630, 0.680546, 0.665455, 0.650196, 0.633707, 0.618217, 0.605972, 0.592923, 0.578437, 0.563725, 0.551464, 0.538158, 0.519843, 0.500879, 0.486195, 0.472855, 0.458538, 0.440057, 0.422272, 0.402885, 0.383262, 0.361882, 0.338678, 0.316555, 0.298506, 0.279068, 0.255606, 0.227027, 0.201944, 0.174543, 0.143867, 0.096811, 0.044805.

93. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.005167, 0.011981, 0.017841, 0.022244, 0.026553, 0.031068, 0.035846, 0.040391, 0.045182, 0.050268, 0.055649, 0.061057, 0.066831, 0.072674, 0.078826, 0.085156, 0.091575, 0.098293, 0.105681, 0.113773, 0.121601, 0.129022, 0.138047, 0.148204, 0.158398, 0.169204, 0.179212, 0.188430, 0.198946, 0.210257, 0.222133, 0.236050, 0.251162, 0.266475, 0.282524, 0.298583, 0.315814, 0.334517, 0.352428, 0.372199, 0.388440, 0.400000, 0.408924, 0.424639, 0.440411, 0.455531, 0.469013, 0.481291, 0.492587, 0.504662, 0.514708, 0.524576, 0.535741, 0.547732, 0.558973, 0.567273, 0.575847, 0.585113, 0.594603, 0.603477, 0.610688, 0.621035, 0.635554, 0.648061, 0.658219, 0.669725, 0.681601, 0.691051, 0.702236, 0.713983, 0.726843, 0.742869, 0.760467, 0.776139, 0.790253, 0.805735, 0.822836, 0.842261, 0.861448, 0.874584, 0.888622, 0.905988, 0.920321, 0.929926, 0.935623, 0.943977, 0.953429, 0.959648, 0.965468, 0.973359, 0.978007, 0.981078, 0.982898, 0.985956, 0.993341, 0.996419, 0.997015, 0.998812, 1.000000, 0.997307, 0.997038, 0.993513, 0.990205, 0.988309, 0.987577, 0.984662, 0.984077, 0.981707, 0.978162, 0.968782, 0.960647, 0.952468, 0.945065, 0.934680, 0.923900, 0.908954, 0.894633, 0.878203, 0.854567, 0.828177, 0.804822, 0.783795, 0.768115, 0.758442, 0.745928, 0.728510, 0.712191, 0.694841, 0.679219, 0.663613, 0.647964, 0.631325, 0.616391, 0.603800, 0.590816, 0.575476, 0.561171, 0.549193, 0.535428, 0.516958, 0.497337, 0.482519, 0.469258, 0.454658, 0.436620, 0.419015, 0.399476, 0.379941, 0.357838, 0.335101, 0.313163, 0.295549, 0.276211, 0.253050, 0.224296, 0.199336, 0.172305, 0.141446, 0.095822, 0.043428.

94. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.070562, 0.153128, 0.223865, 0.277425, 0.328933, 0.378871, 0.428875, 0.466903, 0.502980, 0.540652, 0.577244, 0.609723, 0.642362, 0.674990, 0.707747, 0.736262, 0.760856, 0.788273, 0.816040, 0.841368, 0.858992, 0.873773, 0.885881, 0.900523, 0.915344, 0.929774, 0.939798, 0.950042, 0.962399, 0.968204, 0.970958, 0.975734, 0.981824, 0.986343, 0.992673, 0.993414, 0.995410, 0.997931, 1.000000, 0.999860, 0.997476, 0.992981, 0.991523, 0.995583, 0.994843, 0.992621, 0.988573, 0.981661, 0.976992, 0.970282, 0.957811, 0.945250, 0.935463, 0.924735, 0.911861, 0.894891, 0.875673, 0.853912, 0.829581, 0.800928, 0.772311, 0.746186, 0.723912, 0.699601, 0.673284, 0.644950, 0.615699, 0.583216, 0.549339, 0.516426, 0.483577, 0.449650, 0.417677, 0.384197, 0.342482, 0.299194, 0.251046, 0.203717, 0.143021, 0.065645.

95. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.006415, 0.014344, 0.020862, 0.026466, 0.032741, 0.038221, 0.043563, 0.049250, 0.055802, 0.061948, 0.068462, 0.075503, 0.082891, 0.091060, 0.099387, 0.107183, 0.115549, 0.125696, 0.136339, 0.145789, 0.153726, 0.164265, 0.177223, 0.190620, 0.203830, 0.218639, 0.233720, 0.249049, 0.265556, 0.283663, 0.301964, 0.321712, 0.342502, 0.366081, 0.387070, 0.409486, 0.433703, 0.459761, 0.484018, 0.506433, 0.529354, 0.554275, 0.573650, 0.588944, 0.604544, 0.625227, 0.643944, 0.657806, 0.671353, 0.685982, 0.698897, 0.711467, 0.725355, 0.741354, 0.756273, 0.765480, 0.775370, 0.784991, 0.794184, 0.803647, 0.813314, 0.820924, 0.828048, 0.837550, 0.847912, 0.859458, 0.864498, 0.872769, 0.881746, 0.887154, 0.893044, 0.903660, 0.911780, 0.921050, 0.929696, 0.938064, 0.948338, 0.962459, 0.971763, 0.981208, 0.985637, 0.988682, 0.989031, 0.992217, 0.994877, 0.997749, 1.000000, 0.997620, 0.992235, 0.989169, 0.983648, 0.977653, 0.971034, 0.965202, 0.956660, 0.947502, 0.935108, 0.925332, 0.914033, 0.898499, 0.878527, 0.863358, 0.849252, 0.832491, 0.810874, 0.788575, 0.762177, 0.731820, 0.699031, 0.663705, 0.627703, 0.592690, 0.556744, 0.514179, 0.461483, 0.407341, 0.345522, 0.281674, 0.196834, 0.091395.

96. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.018978, 0.041846, 0.060817, 0.076819, 0.093595, 0.108198, 0.122666, 0.138033, 0.154986, 0.171591, 0.189209, 0.207549, 0.226215, 0.245981, 0.266572, 0.284281, 0.304491, 0.328674, 0.351175, 0.367542, 0.380520, 0.399448, 0.420786, 0.437700, 0.453915, 0.472322, 0.489550, 0.503780, 0.518673, 0.530716, 0.543991, 0.558394, 0.574137, 0.587292, 0.598577, 0.610690, 0.622885, 0.634574, 0.644980, 0.655282, 0.669466, 0.686476, 0.700466, 0.709844, 0.719805, 0.733387, 0.745502, 0.754031, 0.764355, 0.778127, 0.789710, 0.799068, 0.812027, 0.827640, 0.844369, 0.857770, 0.869695, 0.886236, 0.906606, 0.924391, 0.934815, 0.943317, 0.948257, 0.955726, 0.965829, 0.975723, 0.980533, 0.985198, 0.992322, 0.994076, 0.992745, 0.993815, 0.994970, 0.996295, 1.000000, 0.997513, 0.996372, 0.997335, 0.994443, 0.990290, 0.985497, 0.978662, 0.972400, 0.972717, 0.969570, 0.964077, 0.957477, 0.949231, 0.940475, 0.930178, 0.915011, 0.899944, 0.887190, 0.874297, 0.859036, 0.838769, 0.817087, 0.792972, 0.765056, 0.733384, 0.701939, 0.673224, 0.649277, 0.625261, 0.598574, 0.570586, 0.541216, 0.510761, 0.478517, 0.447402, 0.416432, 0.385819, 0.356005, 0.325158, 0.288197, 0.252122, 0.212228, 0.171692, 0.119241, 0.053863.

97. A computer readable storage medium storing computer readable data comprising an optimized window for use with a linear predictive analysis procedure s of an ITU-T G 729 standard, the optimized window comprising a first plurality of sample values, wherein the first plurality of sample values comprises: 0.032368, 0.070992, 0.104001, 0.130989, 0.158618, 0.183311, 0.209813, 0.235893, 0.263139, 0.290663, 0.319418, 0.349405, 0.380787, 0.413518, 0.446571, 0.475812, 0.508718, 0.548017, 0.584584, 0.607285, 0.623716, 0.648710, 0.673015, 0.691285, 0.710126, 0.730009, 0.748768, 0.763481, 0.778534, 0.790593, 0.803461, 0.814148, 0.826917, 0.836676, 0.844328, 0.853257, 0.862934, 0.870774, 0.876733, 0.883246, 0.892043, 0.903228, 0.911752, 0.916944, 0.922037, 0.928852, 0.934055, 0.937002, 0.941260, 0.947170, 0.949587, 0.950625, 0.955168, 0.960953, 0.968763, 0.972807, 0.973065, 0.976498, 0.982413, 0.986591, 0.988961, 0.989838, 0.989248, 0.992486, 0.995513, 0.998614, 0.999549, 1.000000, 0.999652, 0.997571, 0.992708, 0.988906, 0.987096, 0.985167, 0.986103, 0.982236, 0.978635, 0.977097, 0.973180, 0.967504, 0.960993, 0.951541, 0.942105, 0.941105, 0.939154, 0.932846, 0.923188, 0.912594, 0.903162, 0.891309, 0.874549, 0.857906, 0.843536, 0.829542, 0.813114, 0.791248, 0.766908, 0.736502, 0.699416, 0.659532, 0.621899, 0.586649, 0.559063, 0.531663, 0.502472, 0.473266, 0.443670, 0.413039, 0.382995, 0.354757, 0.327742, 0.301987, 0.275724, 0.248407, 0.217190, 0.187928, 0.157322, 0.127304, 0.087168, 0.038800.

98. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.022638, 0.049893, 0.073398, 0.091759, 0.110170, 0.126403, 0.143979, 0.161140, 0.178336, 0.194547, 0.211645, 0.231052, 0.251342, 0.271996, 0.292451, 0.312423, 0.333549, 0.355545, 0.376768, 0.396785, 0.417081, 0.442956, 0.473160, 0.502298, 0.530133, 0.558464, 0.590280, 0.624473, 0.662582, 0.692886, 0.712825, 0.733828, 0.751837, 0.770836, 0.787658, 0.805155, 0.820733, 0.834659, 0.845647, 0.855709, 0.866900, 0.882317, 0.895480, 0.905044, 0.913294, 0.923179, 0.930585, 0.937805, 0.945655, 0.953583, 0.958026, 0.961559, 0.964647, 0.971273, 0.980345, 0.983826, 0.984393, 0.986661, 0.988407, 0.990593, 0.992878, 0.992387, 0.993311, 0.995638, 0.996021, 0.997546, 1.000000, 0.999479, 0.998087, 0.995468, 0.992561, 0.991342, 0.989436, 0.987899, 0.988164, 0.985124, 0.982922, 0.983393, 0.977788, 0.974029, 0.969894, 0.964447, 0.958461, 0.957896, 0.955135, 0.951701, 0.946896, 0.939734, 0.933706, 0.928074, 0.919777, 0.909893, 0.900927, 0.892969, 0.883315, 0.871214, 0.859219, 0.848186, 0.834842, 0.817133, 0.796229, 0.778367, 0.762923, 0.743623, 0.719600, 0.694968, 0.664921, 0.625471, 0.578317, 0.527732, 0.480384, 0.438591, 0.402137, 0.362915, 0.316804, 0.271267, 0.224062, 0.178894, 0.121786, 0.054482.

99. A computer readable storage medium storing computer readable data comprising an optimized window for use with a linear predictive analysis procedure of an ITU-T G 729 standard, the optimized window comprising a first plurality of sample values, wherein the first plurality of sample values comprises: 0.020460, 0.045083, 0.066383, 0.083309, 0.100691, 0.116443, 0.132084, 0.146273, 0.160321, 0.174568, 0.189298, 0.203568, 0.217862, 0.232409, 0.247273, 0.260606, 0.273681, 0.286389, 0.300298, 0.312947, 0.324128, 0.338319, 0.356184, 0.372224, 0.388061, 0.404936, 0.422500, 0.438661, 0.458192, 0.478784, 0.500707, 0.525751, 0.552009, 0.579318, 0.604901, 0.632992, 0.663769, 0.697784, 0.729886, 0.755063, 0.775634, 0.801067, 0.820260, 0.835611, 0.847438, 0.863815, 0.880576, 0.893437, 0.904934, 0.917732, 0.927039, 0.936925, 0.945466, 0.955971, 0.966724, 0.972415, 0.977788, 0.983337, 0.987107, 0.989729, 0.993216, 0.993077, 0.993032, 0.993864, 0.994757, 0.995481, 0.998028, 1.000000, 0.999625, 0.994891, 0.991095, 0.989700, 0.987494, 0.983622, 0.979496, 0.974914, 0.970786, 0.968301, 0.961302, 0.953409, 0.946868, 0.939263, 0.930691, 0.927281, 0.923373, 0.917657, 0.912348, 0.902403, 0.892379, 0.883578, 0.875732, 0.864583, 0.854513, 0.846606, 0.837772, 0.826760, 0.816543, 0.807560, 0.796882, 0.779644, 0.760555, 0.745676, 0.733771, 0.718454, 0.699926, 0.679620, 0.656820, 0.631938, 0.604826, 0.574119, 0.543804, 0.516049, 0.488212, 0.453966, 0.408583, 0.364608, 0.314635, 0.258365, 0.179497, 0.084086.

100. A computer readable storage medium storing computer readable program code for determining a plurality of optimized unquantized LP coefficients and optimized quantized LP coefficients in a G.729 speech coding standard, the computer readable program code comprising:
data encoding an optimized G.729 window; and
a computer code implementing an improved linear prediction analysis procedure in response to a speech signal, wherein the improved linear prediction analysis procedure:
(A) high pass filters and scales the speech signal to create a preprocessed speech signal, wherein the preprocessed speech signal comprises a plurality of segments;
(B) windows the preprocessed speech signal with an optimized G.729 window to create a frame of the preprocessed speech signal, wherein the frame comprises one of the plurality of segments of the preprocessed speech signal and includes a first subframe and a second subframe;
(C) determines the plurality of optimized unquantized LP coefficients for the frame through autocorrelation;
(D) transforms the plurality of optimized unquantized LP coefficients for the frame into optimized LSP coefficients for the second subframe of the frame;
(E) quantizes the plurality of optimized LSP coefficients for the second frame of the frame to create quantized optimized LSP coefficients for the second frame of the frame;
(F) interpolates the quantized optimized LSP coefficients for the second frame of the frame with optimized LSP coefficients for a second frame of a prior frame to create quantized optimized LP coefficients of the first subframe of the frame;
(G) transforms the quantized optimized LSP coefficients of the first and second subframes of the frame into quantized optimized LP coefficients of the first and second subframes, respectively; and
(H) repeats steps (B) through (G) for each of the plurality of segments of the preprocessed speech signal.

101. The computer readable storage medium, as claimed in claim 100, further comprising data encoding an optimized LSP interpolation factor and the improved linear prediction analysis procedure interpolates the quantized optimized LSP coefficients for the second frame of the frame with optimized LSP coefficients for a second frame of a prior frame using the optimized LSP interpolation factor to create the quantized optimized LP coefficients of the first subframe of the frame.

102. A computer readable storage medium storing computer readable program code for determining a plurality of optimized unquantized LP coefficients and optimized quantized LP coefficients in a G.729 speech coding standard, the computer readable program code comprising:
data encoding an optimized LSP interpolation factor; and
a computer code implementing an improved linear prediction analysis procedure in response to a speech signal, wherein the improved linear prediction analysis procedure:
(A) high pass filters and scales the speech signal to create a preprocessed speech signal, wherein the preprocessed speech signal comprises a plurality of segments;
(B) windows the preprocessed speech signal with a G.729 window to create a frame of the preprocessed speech signal, wherein the frame comprises one of the plurality of segments of the preprocessed speech signal and includes a first subframe and a second subframe;
(C) determines the plurality of unquantized LP coefficients for the frame through autocorrelation;
(D) transforms the plurality of unquantized LP coefficients for the frame into LSP coefficients for the second subframe of the frame;
(E) quantizes the plurality of LSP coefficients for the second frame of the frame to create quantized LSP coefficients for the second frame of the frame;
(F) interpolates the quantized LSP coefficients for the second frame of the frame with LSP coefficients for a second frame of a prior frame using the optimized LSP interpolation factor to create quantized optimized LP coefficients of the first subframe of the frame;
(G) transforms the quantized optimized LSP coefficients of the first subframe of the frame and the quantized LSP coefficients of the second subframe of the frame into quantized optimized LP coefficients of the first subframe of the frame and quantized LP coefficients of the second subframe of the frame, respectively, and
(H) repeats steps (B) through (G) for each of the plurality of segments of the preprocessed speech signal.

103. A computer readable storage medium storing computer readable program code for determining a synthesis filter and an excitation signal for each frame of a speech signal, the computer readable program code comprising:
data encoding an optimized G.729 window; and
a computer code implementing an improved G.729 standard in response to a speech signal, wherein the improved G.729 standard performs an improved linear predictive analysis procedure using the optimized G.729 window to produce optimized unquantized LP coefficients for the frame and optimized quantized LP coefficients for a first and second subframe of the frame; defines the synthesis filter for the frame using the optimized unquantized LP coefficients and determines the excitation signal for the first and second subframes using the optimized quantized LP coefficients; and repeats performing the improved linear predictive analysis procedure and defining the synthesis filter for each frame of the speech signal and determining the excitation signal for the first and second subframes for each frame of the speech signal.

104. The computer readable storage medium, as claimed in claim 103, further comprising, data encoding an optimized LSP interpolation factor, and wherein improved linear prediction analysis procedure interpolates the quantized optimized LSP coefficients for the second frame of the frame with optimized LSP coefficients for a second frame of a prior frame using the optimized LSP interpolation factor to create the quantized optimized LP coefficients of the first subframe of the frame.

105. A computer readable storage medium storing computer readable program code for determining a synthesis filter and an excitation signal for each frame of a speech signal, the computer readable program code comprising:
data encoding an optimized LSP interpolation factor; and
a computer code implementing an improved G.729 standard in response to a speech signal, wherein the improved G.729 standard performs an improved linear predictive analysis procedure using the optimized LSP interpolation factor to produce unquantized LP coefficients for the frame, quantized LP coefficients for a s first subframe of the frame and optimized quantized LP coefficients for a second subframe of the frame; defines the synthesis filter for the frame using the unquantized LP coefficients and determines an excitation signal for the first and second subframes using the quantized LP coefficients and the optimized quantized LP coefficients; and repeats performing the improved linear predictive analysis procedure and defining the synthesis filter for each frame of the speech signal and determining an excitation signal for the first and second subframes for each frame of the speech signal.

106. An optimization device for optimizing a G.729 window, comprising:
a memory device, wherein the memory device stores an alternate window optimization procedure and the G.729 window;
an interface;
a processor, coupled to the interface and the memory device, wherein the processor receives training data from the interface via an interface signal and optimizes the G.729 window using the training data and the alternate window optimization procedure to produce an optimized G.729 window, wherein the G.729 window and the alternate window optimization procedure are communicated to the processor by the memory device via a memory signal, and the processor communicates the optimized G.729 window to the memory device via processor signal.

107. An optimization device for optimizing a G.729 LSP interpolation factor, comprising:
a memory device, wherein the memory device stores an LSP interpolation factor optimization procedure and the G.729 LSP interpolation factor;
an interface;
a processor, coupled to the interface and the memory device, wherein the processor receives training data from the interface via an interface signal and optimizes the G.729 LSP interpolation factor using the training data and the LSP interpolation factor optimization procedure to produce an optimized G.729 LSP interpolation factor, wherein the G.729 LSP interpolation factor and the LSP interpolation factor optimization procedure are communicated to the processor by the memory device via a memory signal, and the processor communicates the optimized G.729 LSP interpolation factor to the memory device via processor signal.

108. An optimization device for optimizing a G.729 window and a G.729 LSP interpolation factor, comprising:
a memory device, wherein the memory device stores a joint window and LSP interpolation factor optimization procedure, the G.729 window and the G.729 LSP interpolation factor;
an interface;
a processor, coupled to the interface and the memory device, wherein the processor receives training data from the interface via an interface signal and optimizes the G.729 window and the G.729 LSP interpolation factor using the training data and the joint window and LSP interpolation factor optimization procedure to produce an optimized G.729 window and an optimized LSP interpolation factor, wherein the G.729 window, the G.729 LSP interpolation factor and the joint window and LSP interpolation factor optimization procedure are communicated to the processor by the memory device via a memory signal, and the processor communicates the optimized G.729 window and the optimized G.729 LSP interpolation factor to the memory device via processor signal.
